(19) United States
(12) Patent Application Publication
(10) Pub. No.: US 2004/0117164 A1
(43) Pub. Date: Jun. 17, 2004

(54) Method and system for artificial intelligence directed lead discovery in high throughput screening data

(75) Inventors: John W. Elling, Santa Fe, NM (US); Susan I. Bassett, Santa Fe, NM (US)

Correspondence Address: Lawrence H. Aaronson, McDonnell Boehnen Hulbert & Berghoff, 32nd Floor, 300 S. Wacker Drive, Chicago, IL, 60606, US

(73) Assignee: Bioreason, Inc.

(21) Appl. No.: 10/649,596

(22) Filed: Aug. 27, 2003

Related U.S. Application Data
(63) Continuation of application No. 09/281,990, filed on Mar. 29, 1999, now abandoned.
(60) Provisional application No. 60/120,701, filed on Feb. 19, 1999.

(51) Int. Cl. G06G 7/48; G06G 7/58

(52) U.S. Cl. 703/11

(57) ABSTRACT

A computer based system for analyzing a set of data objects and establishing a mechanism model representing a set of features that is likely to correlate with a specified response characteristic. A computer may establish a description for each of the data objects based on a comparison between a set of descriptors and features of the data objects. The computer may then select a group of the data objects that have similar descriptions and that represent the specified response characteristic. The computer may then adaptively learn a mechanism model by mapping the discriminating features of the group back to the objects in the group. The computer may further designate the mechanism model as a new descriptor and iteratively repeat the process to establish yet an improved mechanism model. The invention is particularly well suited for use in establishing pharmacophores representing chemical structures that are likely to correlate with activity in a particular assay.

### RELATED APPLICATIONS

This application claims priority to U.S. provisional patent application No. 60/120,701, entitled “Artificial Intelligence Directed Lead Discovery,” filed Feb. 19, 1999, by Susan I. Bassett, Andrew P. Dalke, John W. Elling, Brian P. Kelley, Christodoulos A. Nicolaou, and Ruth F. Nutt, the entirety of which is hereby incorporated herein by reference.

### COPYRIGHT

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all United States and International copyright rights whatsoever.

### BACKGROUND OF THE INVENTION

1. Field of the Invention

The present invention relates to computer-based analysis of data and generally to the computer-based correlation of data features with data responses, in order to determine or predict which features correlate with or are likely to result in one or more responses. The invention is particularly suitable for use in the fields of chemistry, biology and genetics, such as to facilitate computer-based correlation of chemical structures with observed or predicted pharmacophoric activity. The invention is particularly useful in facilitating the identification and development of potentially beneficial new drugs.

For purposes of illustration, the invention will be described primarily in the context of computer-based analysis of chemical structure-activity relationships (SAR). However, based on the present disclosure, those of ordinary skill in the art will appreciate that the invention may be applicable in other related or unrelated areas as well. By way of example and without limitation, the invention may be applicable in genetics and antibody-protein analysis.

2. Description of Related Art

The global biotech and pharmaceutical industry is a $200 billion/year business. Most of the estimated $13 billion R&D spending in this industry is focused on discovering and developing prescription drugs. Current R&D effort is characterized by low drug discovery rates and long time-to-market.

In an effort to accelerate drug discovery, biotech and pharmaceutical firms are turning to robotics and automation. The old methods of rationally designing molecules using known structural relationships are being supplanted by a shotgun approach of rapidly screening hundreds of thousands of molecules for biological activity. High Throughput Screening (HTS) is being used to test large numbers of molecules for biological activity. The primary goal is to identify hits or leads, which are molecules that affect a particular biological target in the desired manner. For instance and without limitation, a lead may be a chemical structure that binds particularly well to a protein.

Automated HTS systems are large, highly automated liquid handling and detection systems that allow thousands of molecules to be screened for biological activity against a test assay. Several pharmaceutical and biotech companies have developed systems that can perform hundreds of thousands of screens per day.

The increasing use of HTS is being driven by a number of other developments in the industry. The greater the number and diversity of molecules that are run through screens, the more successful HTS is likely to be. This fact has propelled rapid developments in molecule library collection and creation. Combinatorial chemistry systems have been developed that can automatically create hundreds of thousands of new molecules. Combinatorial chemistry is performed in large automated systems that are capable of synthesizing a wide variety of small organic molecules using combinations of “building block” reagents. HTS systems are the only way that the enormous volume of new molecules generated by combinatorial chemistry systems can be tested for biological activity. Another force driving the increased use of HTS is the Human Genome program and the companion field of bioinformatics that is enabling the rapid identification of gene function and accelerating the discovery of therapeutic targets. Companies do not have the resources to develop an exhaustive understanding of each potential therapeutic target. Rather, pharmaceutical and biotech companies use HTS to quickly find molecules that affect the target and may lead to the discovery of a new drug.

High throughput screening does not directly identify a drug. Rather the primary role of HTS is to detect lead molecules and supply directions for their optimization. This limitation exists because many properties critical to the development of a successful drug cannot be assessed by HTS. For example, HTS cannot evaluate the bioavailability, pharmacokinetics, toxicity, or specificity of an active molecule. Thus, further studies of the molecules identified by HTS are required in order to identify a potential lead to a new drug.

The further study, a process called lead discovery, is a time- and resource-intensive task. High throughput screening of a large library of molecules typically identifies thousands of molecules with biological activity that must be evaluated by a pharmaceutical chemist. Those molecules that are selected as candidates for use as a drug are studied to build an understanding of the mechanism by which they interact with the assay. Scientists try to determine which molecular properties correlate with high activity of the molecules in the screening assay. Using the drug leads and this mechanism information, chemists then try to identify, synthesize and test molecules analogous to the leads that have enhanced drug-like effect and/or reduced undesirable characteristics in a process called lead optimization. Ideally, the end result of the screening, lead discovery, and lead optimization is the development of a new drug for clinical testing.

As the number of molecules in the test library and the number of therapeutic target assays exponentially increase, lead discovery and lead optimization have become the new bottleneck in drug discovery using HTS systems. Because of the large number of HTS results that must be analyzed, scientists often seek only first-order results such as the identification of molecules in the library that exhibit high assay activity. In one method, for instance, all of the molecules in the data set are divided into groups based on common properties of their molecular structures. An analysis is then made to determine which groups contain molecules with high activity levels and which groups contain molecules with low activity levels. Those groups representing high activity levels are then deemed to be useful groups. Commonly, the analysis will stop at this point, leaving chemists to analyze the members of the active groups in search of new or optimized leads.

### SUMMARY OF THE INVENTION

The present invention provides a computer-based system (e.g., method, apparatus and/or machine) for automatically analyzing a data set and discovering scientifically useful groups of features that are likely to correlate with observed or predicted responses. A group of features that is likely to correlate with a particular response characteristic may be referred to as a “mechanism model.”

In the chemistry field, for instance, the invention may provide a computer-based system for analyzing a set of data resulting from an HTS screen of a heterogeneous library of molecules and for establishing a mechanism model or pharmacophore representing a chemical structure that is likely to correlate with a particular activity characteristic. In chemistry, a pharmacophore representation can be any combination of atoms and bonds in a two or three dimensional representation of a molecule and/or physical properties conveyed by the arrangement of particular atoms and bonds such as proton donors and proton acceptors, electron density in space, etc. As used herein, the term “pharmacophore” may mean, without limitation, a representation of any chemical feature or combination of chemical features, including but not limited to features that may be represented in two or three dimensions (e.g., atoms and bonds) and/or other features (e.g., properties associated with the arrangement of atoms and bonds such as proton donors and proton acceptors, electron density space, molecular weight, molecular dipole, etc.). In this sense, the term “pharmacophore” may refer to the mechanism by which molecules in the library interact with a specified target or the mechanism by which molecules evidence any other activity. Further as used herein, the term “structure” may mean, without limitation, a two or three-dimensional arrangement of atom(s) and bond(s) and/or one or more properties conveyed by an arrangement of atom(s) and bond(s).

As a general matter, the invention may involve the analysis of a group of entities, each of which has a set of features and a measured response characteristic. By way of example, these entities may be chemical molecules, each of which may be composed of various chemical components (e.g., atoms and bonds), and each of which may have an established activity characteristic (e.g., how well it bound to a particular protein). As indicated above, existing methods for analysis of such entities may involve dividing the entities into groups according to the similarity of their features and then identifying which group of similarly-featured entities has a desired response characteristic. Such existing art thus addresses the question of how well a given sub-classification distinguishes active molecules from inactive molecules.

At issue, however, is how to identify what similarities in the features of the entities account for similarities in their respective response characteristics. Thus, in chemistry, for instance, at issue is how to identify what chemical substructure (or composite structure) accounts for similarities in activity of various molecules. This analysis is particularly problematic when the information content of the features that are used to describe the entities is limited. For instance, where the descriptors are not independent from each other and/or are particularly fragmented (such as atoms and bonds for describing molecules), the descriptors may not contain enough information to fully explain similarities in features of the entities that are responsible for similarities in their response characteristics.

According to an exemplary embodiment, the present invention provides a computer-based system for discovering mechanism models in a way that is not necessarily limited by the information content of the available descriptors. As presently contemplated, a computer may receive input data representing a set of entities. The computer may describe the entities respectively according to an initial set of descriptors, for instance establishing a descriptor vector (e.g., a bit string) for each entity. The computer may then select a group of entities that have similar features as described and that also have a high concentration of a specified response characteristic. The computer may do so, for instance, by clustering the entities according to their descriptor vectors and then selecting one or more groups of clustered entities (e.g., a cluster or neighborhood of clusters) that has a high concentration of the specified response characteristic, or through any other suitable means (e.g., linear regression, etc.) Advantageously, as presently contemplated, the computer may then map the discriminating features of each selected group back to the entities within the group, in order to identify a subset of common features or components of the entities. Preferably, the subset is the maximum common subset (e.g., the largest composite set of features common to all entities in the selected group). This subset of common features or components may reasonably be deemed responsible for the similarity in response characteristics of the entities in the selected group and may therefore constitute a mechanism model. The computer may then output an indication of the adaptively discovered mechanism model(s).

Further, as presently contemplated, the computer may make use of the adaptively discovered mechanism model(s) in order to adaptively discover yet a better, more commercially valuable mechanism model. In particular, the computer may add the newly discovered mechanism model as a new descriptor to the set of descriptors used to characterize the entities, and the computer may then repeat the process described above. The computer may again describe the entities according to the set of descriptors, now beneficially including the newly added descriptor, and the computer may again select a group of entities that have similar features and similar response characteristics, and the computer may again map the discriminating features of the selected group back to the entities in the group so as to discover a better mechanism model. With this iterative process, the analysis is no longer limited by the restricted information content of the initial set of descriptors but instead benefits from the enhanced information content that is adaptively established as the process proceeds.

In practice, the computer may output various data representing the results of its analysis, and this output may be commercially valuable to scientists or technicians, as it may represent—or facilitate development of—new entities that have features likely to give rise to the specified response characteristic. For instance, the computer may output a set of data (e.g., a bit string) representing the largest or most composite mechanism model that it has established. As another example, the computer may output a set of data indicating the discriminating features and response characteristics associated with each of the entity-groupings in the final iteration. This information could then be used in practice to virtually screen test-entities with unknown response characteristics, such as by identifying which group a test-entity most closely matches and concluding that the test-entity will likely have a response characteristic similar to the other entities in the group. As still another example, the computer may output a data set indicating how the data objects are clustered after the final iteration, which may be used in practice by a scientist or technician to manually identify “useful” groupings.

According to one aspect, the present invention may include a system for adaptively learning what substructure(s) are responsible for subclassifications of chemical molecules, even where those subclassifications divide active molecules from other active molecules (rather than strictly active from inactive). In an exemplary embodiment, the adaptive learning system may operate for instance by clustering a set of molecules according to their molecular structure as characterized by an initial set of descriptors, identifying the clusters that represent a high level of activity, and analyzing those clusters to identify the most common substructure(s) among the molecules in the clusters, which may reasonably be correlated to the observed activity level.

These adaptively learned substructures may then serve as new descriptors for use in further classifying the molecules in order to identify pharmacophoric mechanisms or processes (e.g., rules) for building pharmacophores. Thus, rather than merely determining how well a particular subgroup distinguishes active molecules from inactive molecules, the present invention may go further and determine the reason or reasons for the distinction: namely, the responsible substructures. An iterative identification of these substructures can in turn be used to establish complete pharmacophoric mechanisms.

According to yet another aspect, for instance, the invention may provide a system for automatically learning new pharmacophoric mechanisms. In an exemplary embodiment, for instance, the system may employ a first set of descriptors to adaptively learn one or more new descriptors that appear to be responsible for observed activity with respect to a set of molecules. The system may then add the new descriptors to the first set of descriptors, to establish a second set of descriptors. The system may then iteratively repeat the process with respect to the set of molecules, until a predetermined stopping point or until a determination is made that no additional useful information is likely to be being gleaned. As a result, the system may produce one or more pharmacophoric mechanisms, each optimally representing a maximum common substructure that is likely to result in the observed or desired activity.

The foregoing as well as other advantages and features of the present invention will be understood by those of ordinary skill in the art by reading the following detailed description with reference where appropriate to the accompanying drawings.

### BRIEF DESCRIPTION OF THE DRAWINGS

An exemplary embodiment of the present invention is described herein with reference to the drawings, in which:

FIG. 1 is a flow chart illustrating an exemplary set of functions that a computer may perform according to an embodiment of the present invention;

FIG. 2 is a flow chart illustrating an exemplary set of functions that a computer may perform to analyze chemical structure-activity relationships according to an embodiment of the present invention;

FIG. 3 (four parts) is a table listing an illustrative set of starting descriptors for use in an embodiment of the present invention;

FIG. 4 (two parts) is a flow chart illustrating an exemplary set of functions that a computer may perform to generate descriptor vectors according to an embodiment of the present invention;

FIG. 5 is a flow chart illustrating an exemplary set of functions that a computer may perform to identify hot spots according to an embodiment of the present invention;

FIG. 6 is a flow chart illustrating an exemplary set of functions that a computer may perform to learn one or more new keys according to an embodiment of the present invention; and

FIG. 7 is a flow chart illustrating an exemplary set of functions that a computer may perform to confirm proposed new keys according to an embodiment of the present invention.

### DETAILED DESCRIPTION OF AN EXEMPLARY EMBODIMENT

As indicated above, the present invention provides a computer-based system for the automated analysis of a data set. The system is configured to correlate features with responses and to thereby identify or discover scientifically useful subclasses of features or mechanism models, namely, features that are likely to correspond to observed or predicted responses.

An exemplary embodiment of the invention provides a computer-based system for adaptively and iteratively learning chemical structure subclasses and thereby establishing one or more pharmacophores that are likely to result in observed or predicted levels of chemical or biological activity. Those of ordinary skill in the art of data mining and artificial intelligence will appreciate from reading this description, however, that there are numerous other practical applications for the invention, and additional applications may be developed in the future. Therefore, the invention may extend both generally to other applications as well as specifically to particular applications in chemistry and biology.

The functional steps described herein are preferably encoded in a set of machine language instructions (e.g., source code compiled into object code), which are stored in a computer memory or other storage medium (e.g., a computer disk or tape) and executed by a general purpose computer. (Alternatively, the functional steps may be carried out by appropriately configured circuitry.) The present invention may thus take the form of a computer-based system, which itself may comprise, for example, (i) a method for performing a plurality of functional steps, (ii) a computer readable medium (such as a disk, tape or other storage device) containing a set of encoded machine language instructions executable by a computer processor for performing a plurality of functional steps, and/or (iii) a machine (such as a general purpose digital computer) programmed with a set of machine language instructions for carrying out a plurality of functional steps. Provided with this disclosure, those of ordinary skill in the art will be able to readily prepare a suitable set of instructions for performing these functions and to configure a general purpose computer to operate the instructions.

1. Generalized Analysis

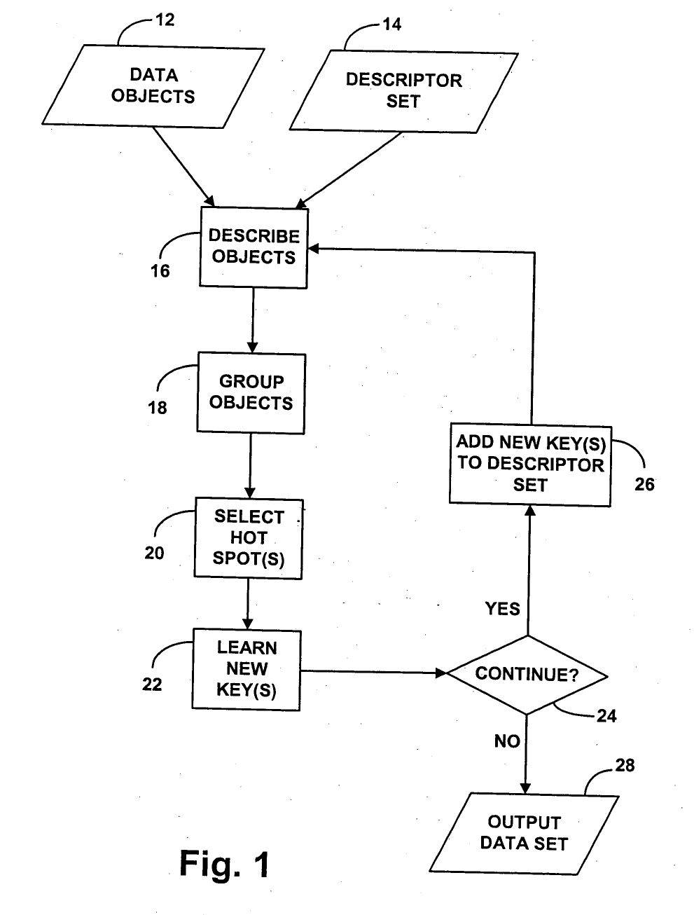

Referring to the drawings, FIG. 1 is a flow chart illustrating an exemplary set of functions that a computer may perform according to an embodiment of the present invention. It will be appreciated that a computer-system may be readily programmed to execute an appropriate set of machine language instructions designed to carry out some or all of these functions as well as other functions if desired.

As shown in FIG. 1, at block 12, a computer may receive as input or otherwise be programmed with a set of data representing a plurality of data objects, each of which may respectively have features and a response characteristic. The response characteristic of each data object may be one dimensional or multi-dimensional. At block 14, the computer may also receive as input or otherwise be programmed with an initial set of descriptors or “keys” that can be used to define a particular pattern (subgraph) in a data object (graph). Each of these keys may be weighted to indicate the relative importance of the keys, as defined by an expert and/or through computer analysis for instance. The data sets referenced at blocks 12 and 14 may alternatively be a single data set.

At block 16, the computer may then establish a description of each object based on a comparison of the features of the object with the set of keys. The description for each object may take any desired form. By way of example and without limitation, the description for each object may take the form of a descriptor vector (e.g., bit string), each element of which may be a binary indication of whether a corresponding one of the keys in the key set is present or absent in the data object. Each descriptor vector may thus be the length of the key set. Alternatively, it is appreciated that the description may indicate expressly only which descriptors are present, thus implicitly indicating the absence of other descriptors. Further alternatively, rather than having the computer generate a description for each data object, the input data set may instead include pre-established descriptions for each data object (e.g., descriptor vectors for a first iteration).

As presently contemplated, the computer may then select one or more groups of the data objects, each group preferably consisting of objects that have similar feature descriptions and that are characterized by a specified response characteristic (e.g., level of a specified response). Any statistical or other mechanism may be used to group the objects for this purpose. For example, the computer may group the objects according to their feature similarity (as embodied in the descriptions established for each object) and then select those groups whose objects exhibit the specified response characteristic. Alternatively, for example, the computer may simultaneously group the objects along both feature and response dimensions, as for instance using stepwise linear regression. Blocks 18 and 20 illustrate the first of these examples.

Referring to block 18, the computer may group the data objects according to similarity of their descriptor vectors. This function may thus involve grouping the descriptor vectors according to their similarity. Those skilled in the art are familiar with numerous computer-based methods for grouping such vectors, any of which can be applied at this stage. As presently contemplated, however, a exemplary method of grouping the vectors should provide neighborhood information, in the form of localized groups of vectors, such that the grouping evidences similar groups as well as similar vectors within each group. An example of one such suitable grouping method is clustering, such as provided for instance by the well known Kohonen Self-Organizing Map (SOM). Of course, other examples of grouping (and, more particularly, clustering) exist as well.

At block 20, the computer may then identify one or more groups whose data objects have a particular or sufficient concentration of the specified response. If, at block 18, the computer performed SOM clustering based on the object descriptions, then, at block 20, the analysis may involve identifying a cluster or neighborhood of clusters that have a sufficient concentration of the specified response characteristic. The determination of what constitutes a sufficient concentration of the specified response characteristic is a matter of design choice. By way of example, the determination may be based on the percentage and/or number of objects in the group that have the specified response characteristic and/or the absence from the group of objects that have a particular response characteristic (such as a characteristic contrary to that specified). The computer may designate each such selected group (one or more) as a “hot spot.”

In an exemplary embodiment, each hot spot may have a set of discriminating features defining the feature-similarity of objects in the group. Reasonably assuming that the objects are all not identical, this set of discriminating features will not describe all of the objects in the selected group but may instead represent a closest fit or closest match to the descriptions of the objects in the group. In a trained SOM map, for instance, each cluster typically defines a template or vector of weighted keys, which is a closest fit or closest match for the descriptor vectors of the objects in the cluster. If the hot spot is a single cluster, the template of the single cluster may thus define the discriminating features of the hot spot. Alternatively, if the hot spot is a neighborhood of clusters, the template of a core cluster or some function of the templates of all clusters in the neighborhood may define the discriminating features.

At block 22, the computer may next advantageously learn one or more new keys from each hot spot. To do so as presently contemplated, the computer may actively map the discriminating features of the hot spot back to the data objects in the hot spot, so as to discover what features or components (i.e., aspects) of the objects contributed most extensively to the similarity of the objects (i.e., what it is about the objects that caused the statistical analysis to group the objects together). By way of example, and without limitation, the computer may score the features or components of each data object based on the number of times the features or components participate in matching the discriminating features of the hot spot. The computer may then search for a subset of features or components that is common to the objects in the hot spot and that has one of the highest composite scores (e.g., averaged among the objects in the hot spot).

The common subset of features, and particularly the maximum common subset of features, is likely to be responsible for the response characteristic exhibited by objects in the hot spot. Therefore, the computer may deem at least the maximum common subset of features to be a mechanism model for achieving the specified response. Further, assuming that the common subset of features is a different set of features than is defined by any of the existing keys, the common subset of features can itself serve as a useful new key.

Thus, at block 24, the computer may next determine whether to continue generating better mechanism model(s) with the benefit of the newly learned key(s). This determination may be as simple as deciding to stop the process after a predetermined number of iterations or more complex such as deciding whether the keys learned in the latest iteration are sufficiently different from the keys learned in the previous iteration to justify continuing. Of course, the determination may take other forms as well.

If the computer elects to continue or if otherwise desired, then, at block 26, the computer may add the newly learned key(s) to the set of key set applied in block 16. The computer may then return to block 16, so as to again establish descriptions (e.g., descriptor vectors) for each data object, this time with the benefit of an enhanced set of keys (further effectively increasing the length of the descriptor vectors), and so forth. In the exemplary embodiment, during the second or later iteration of this process, when the computer establishes the description of a data object, the computer preferably indicates as absent from the object any key from the initial set (provided at block 14) whose underlying feature(s) are wholly subsumed by any newly learned key(s). In this way, the computer can better continue to build on information learned in successive iterations.

The computer may output an indication of the newly learned key(s), as mechanism models representing features sets likely to give rise to a specified response characteristic. In addition or alternatively, the computer can output other types of data, such as those described above for instance. As shown in FIG. 1, at block 28, by way of example, the computer may provide its output in response to a decision at block 24 that the computer will not continue generating mechanism models with the benefit of the learned key(s). Alternatively, as another example, the computer may provide some or all of its output as it learns new keys (e.g., at the end of each iteration) or at any other desired point.

2. Pharmacophore Development Through

Key Learning and Iterative Clustering

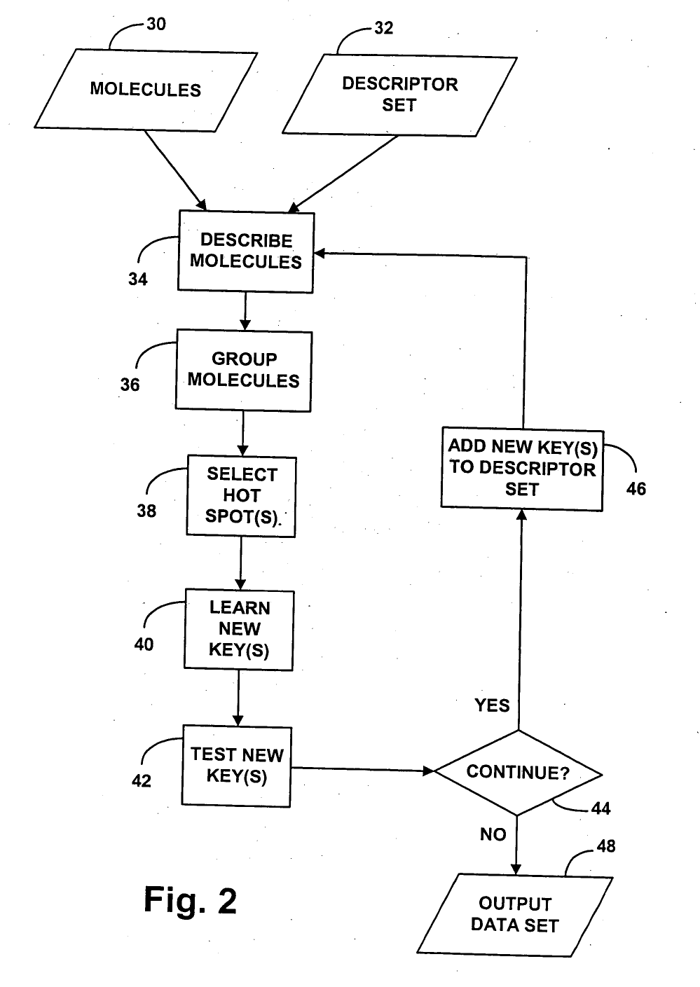

A more particular exemplary embodiment of the invention will now be described in the context of chemical SAR analysis and the development of pharmacophoric mechanism models. Referring to the drawings, FIG. 2 provides an overview of an exemplary set of functions that a computer may perform according to this exemplary embodiment. As in the generalized embodiment described above, it will be appreciated that a computer-system may embody some or all of these functions as well as other desired functions.

An overview of these functions will first be provided, and each function will then be described in more depth so as to enable one of ordinary skill in the art to practice the invention as presently contemplated. In this regard, it will be appreciated that the details of these functions may be extended by analogy to the generalized analysis above, and vice versa.

a. Overview

As shown in FIG. 2, at block 30, the computer may receive or be programmed with a set of digital data representing molecules and their respective activity levels (e.g., potencies or responses). At block 32, the computer may also receive or be programmed with a set of digital data representing an initial set of descriptors or “keys” that may define a particular pattern (subgraph) in a molecule (graph). These patterns preferably relate to physical chemical properties such as atoms, bonds, shapes, sizes, etc. (hereafter referred to generally as “structure”). Therefore, these keys may also be referred to as “substructure keys”, “substructure descriptors” or the like.

At block 34, the computer may establish a description for each molecule. By way of example, the computer may determine with respect to each molecule whether each substructure key is present or absent and may thereby generate a descriptor vector for each molecule. At block 36, the computer may perform a statistical analysis to group all or a subset of the molecules according to the similarity of their descriptions, possibly along dimensions related to their respective activity levels, and preferably in a fashion that provides neighborhood information such as with SOM clustering.

At block 38, the computer may identify one or more groups of structurally similar molecules (e.g., clusters or neighborhoods in the SOM grid) that have a sufficient concentration of active molecules, and the computer may designate each such group as a “hot spot.” At block 40, the computer may adaptively learn one or more new keys from each hot spot, by actively mapping the discriminating features of the hot spot back to the molecules in the hot spot, so as to determine what structural similarity it is that is useful (i.e., to determine what the statistical grouping-analysis learned about the molecules). At block 42, the computer may then verify the efficacy of a newly learned key by determining whether the key also describes active molecules in neighboring (e.g., similar) groups of structurally similar molecules.

At block 44, the computer may then determine whether to iteratively continue to learn additional new keys and build a better pharmacophore, with the benefit of the newly learned key(s). If the computer elects to continue, then, at block 46, the computer may add the newly learned key(s) to the initial set of keys and return to block 34 to repeat the process described above, now with an enhanced set of keys. At block 48, in each iteration and/or after the final iteration (or at any other point(s), such as described above with respect to block 28 in FIG. 1), the computer may output a data set providing commercially valuable information that it has gleaned from the input data set in accordance with the present invention. By way of example, this output data may include data representing one or more newly learned keys, where those learned in the final iteration may constitute the best pharmacophore.

b. Functional Blocks

Receiving data. According to an exemplary embodiment, the computer preferably receives or is programmed with a data set representing molecules and their respective activity levels (i.e., potencies or responses). This data set may result from combinatorial chemistry and/or high throughput screening techniques, or from any other source.

Each molecule is preferably represented by an ASCII string or any other suitable representation that can be computer processed. (Any data string representing a molecule may be referred to as a “molecule data string.”) By way of example and without limitation, a useful system for representing chemical molecules in ASCII form is provided by Daylight Chemical Information Systems, Inc., of Irvine, Calif. Daylight establishes a language that it terms “SMILES” (Simplified Molecular Input Line Entry System), which contains the same information about a molecule that would be found in an extended connection table but sets forth the molecule as a linguistic construct rather than as a data structure. Examples of SMILES strings include:

| | |
|---|---|
| ethane: | CC |
| carbon dioxide: | O═C═O |
| hydrogen cyanide: | C#N |
| riethylamine: | CCN(CC)CC |
| acetic acid: | CC(═O)O |
| cyclohexane: | C1CCCC1 |
| benzene: | c1cccc1 |

A unique molecule may be represented by more than one SMILES string. For example, N² isopropyl benzoylhydrazide may be represented by both the string “c₁ccccc₁(═O)NNC(C)C” and the string “CC(C)NNC(c₁ccccc₁)═O”. The Daylight program therefore generates a connection table, which maps the exact structure of each molecule, in terms of atoms and their bond connections, from various possible representations of the molecule.

As indicated by Daylight, SMILES strings provide a compact, human understandable and machine readable representation of molecules, which can be used for artificial intelligence or expert systems in chemistry. Other information about the creation and use of SMILES strings is readily accessible at Daylight's world wide web site, which is located at http://www.daylight.com, and the reader is directed to the Daylight web site for more detailed information. In addition, further information about SMILES strings is provided in the Journal of Chemical Information and Computer Science, 1988, 28, 31-36.

The molecule representations may be provided in the same or a separate data set as the activity information. For example, a single data file or database may contain separate entries or records for each molecule, including as separate fields (i) a bit string molecule identifier and (ii) a bit string activity identifier. Alternatively, separate data files or databases (or separate tables) may be provided for the molecules and for empirical data gathered with respect to the molecules in one or more assays.

The activity information for a molecule may take any suitable form. By way of example and without limitation, the activity information may be an absolute measure of activity of the molecule in an assay or may be a measure of activity relative to the average activity of all molecules tested in an assay. For instance, a molecule may be tested at various levels of concentration, a curve fit to the concentration vs. activity points, and the concentration necessary to cause half of the maximum activity determined. The activity information for the molecule may then be the resulting IC₅₀ concentration.

Further, the activity information for a molecule may be one-dimensional or multi-dimensional. For instance, the activity may be a single measurement of whether or how well the molecule bound to a particular protein in an assay. This measurement may be indicated, for instance, by an integer (such as a rank between 0 and 3, where 0 indicates inactivity and 3 indicates the highest relative level of activity) or by a Boolean value (where “true” indicates activity and “false” indicates inactivity). Alternatively, the activity may be a multi-dimensional, such as an indication of how the molecule performed in various aspects of a single assay or multiple assays. Such multi-dimensional activity information for a molecule may be represented by a vector, for instance, whose members indicate activity levels of the molecule for a plurality of assays. In any event, the activity information for each molecule is preferably encoded in a format suitable for computer processing, such as in a bit string.

In addition, the computer preferably receives or is programmed with a set of substructure descriptors keys, which can serve to represent aspects of chemical molecules. Each key may be any property that can define a physical aspect of a chemical molecule. By way of example and without limitation, the keys may specify atoms, atom pairs, proton donor-acceptor pairs, other groupings, aromatic rings, characteristics of atoms or sets of atoms (e.g., hydorgen bond affinity, location of electron density, etc.), shapes, sizes and/or orientations. Further, the keys may define 2-D representations (such as atom pairs, bonds and aromatic rings, for example) or 3-D representations (such as a distance between chemical components having variable orientation, and an indication of component orientation, for example).

Each substructure key may be weighted to indicate the relative importance of the key in describing two molecules that are similar. For the initial set of keys, by way of example, these weights may be pre-established (e.g., by a chemist) based on a statistical measurement of how “unusual” it is to find the substructure in a population of molecules; the more unusual the substructure, the more similar are molecules that share the substructure, and so the more highly weighted the key. A different procedure may be used to establish weights for newly learned keys, as will be described in more detail below.

Each substructure key is preferably represented by an ASCII string or any other suitable representation that can be computer processed. (Any data string that represents a descriptor may be referred to as a “descriptor data string.”) By way of example and without limitation, a useful system for representing chemical molecules in ASCII form is also provided by Daylight Chemical Information Systems, Inc. Daylight establishes a language called “SMARTS,” which can be used to specify substructures using rules that are straightforward extensions of SMILES strings. Additional information about Daylight SMARTS keys is provided at the Daylight web site indicated above.

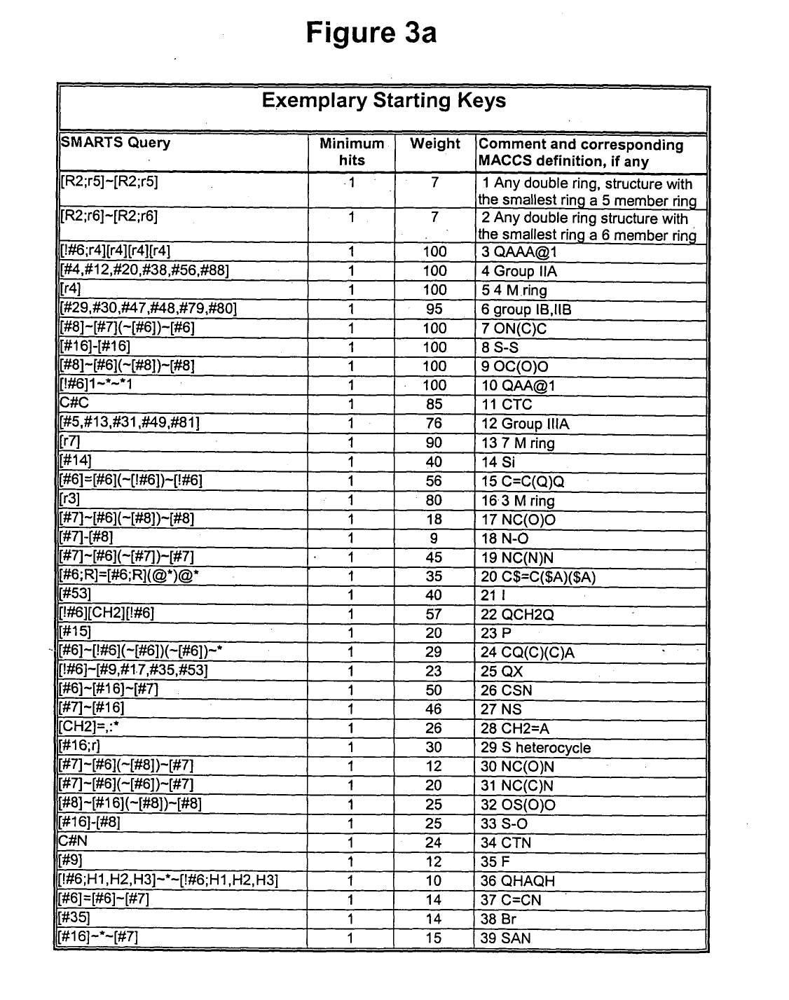

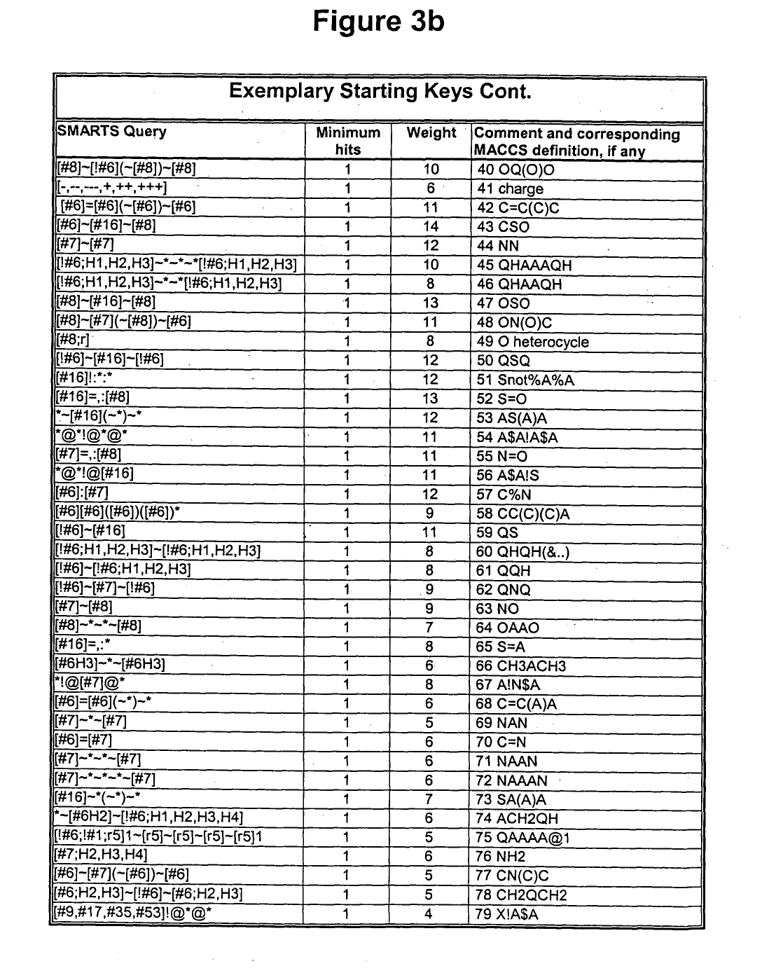

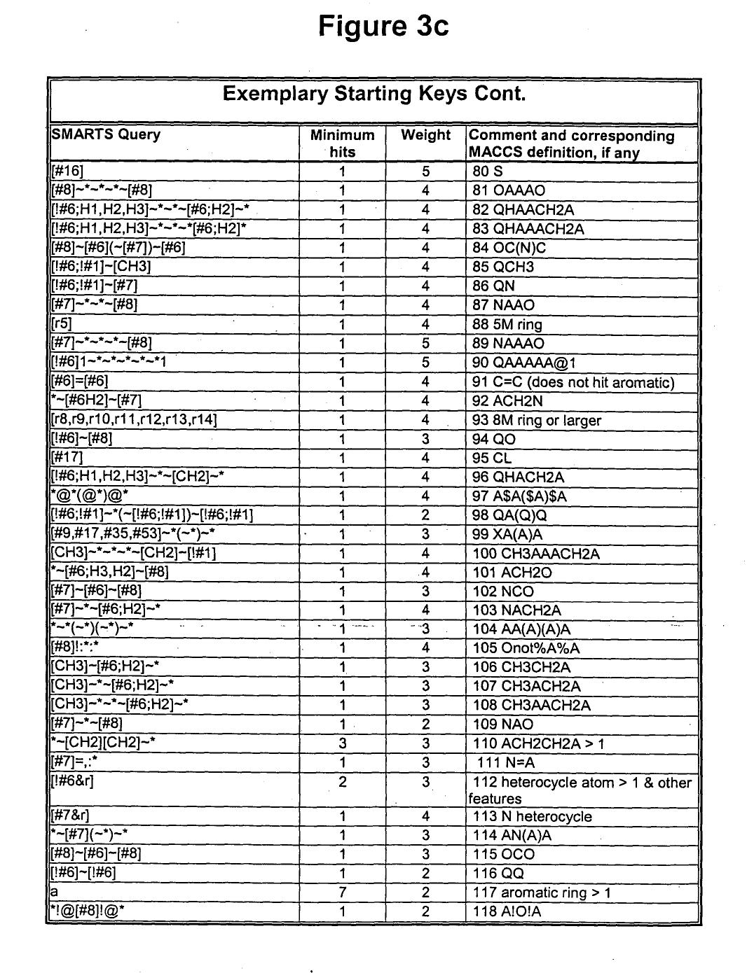

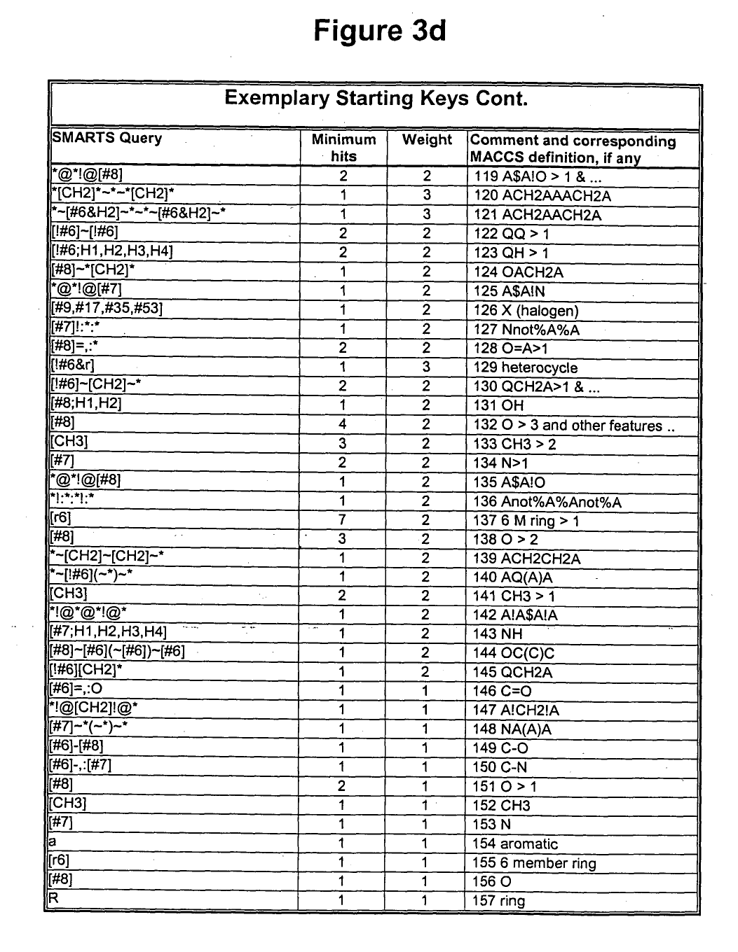

According to Daylight, both SMILES and SMARTS strings employ atoms and bonds as fundamental symbols, which can be used to specify the nodes and edges of a molecule's graph and assign labels to the components of the graph. SMARTS strings are interpreted as patterns that can be matched against SMILES string representations of molecules, in the form of database queries for instance. Other examples of substructure representations include “MACCS” keys (i.e., fragment-based keys for use in describing molecules, where MACCS stands for “the Molecular ACCess System) and other keys as defined by MDL Information Systems, Inc., for instance. (For additional information about the keys established by MDL, the reader is directed to MDL's web site, at http://www.mdli.com.) The initial set of substructure keys may be of any desired size, and the keys may take any desired form. In an exemplary embodiment, however, the computer begins with a set of keys specified in the SMARTS language to emulate 157 of the MACCS keys defined by MDL, which have been selected to provide structural descriptions of molecules and to thereby facilitate improved correlation of structure and activity. FIG. 3 provides a table of these 157 keys as SMARTS string representations and lists for each key an optional weight and a corresponding MDL MACCS definition. Of course, it will be appreciated that other key definitions and forms of keys can be used instead, depending on the features of interest being studied for instance.

Establishing descriptor-vectors. The computer preferably establishes a description of each molecule based on the set of substructure keys. In an exemplary embodiment, without limitation, the description for each molecule may take the form of a descriptor-vector, whose elements indicate whether respective keys in the substructure key set are present or absent in the molecule (i.e., whether the respective substructures are present or absent). If the molecules are represented by SMILES strings and the keys are represented by SMARTS strings, the computer can readily determine whether a key is present in a molecule by querying the corresponding SMARTS string against the corresponding SMILES string (and more particularly the Daylight connection table).

The members of the descriptor vector for a molecule may be values reflecting the weights of the keys that are present in the molecule. By way of example, for each key that is present in a molecule, the corresponding member of the descriptor vector for the molecule may be the weight of the key, and, for each key that is absent, the corresponding member of the descriptor vector may be zero. For instance, if a key has a weight of 5 and the computer deems the key to be present in a molecule, then the computer may assign a value of 5 to the corresponding element of the descriptor vector for the molecule. On the other hand, if the computer deems the key to be absent from the molecule, then the computer may assign a value of 0 to the corresponding vector element.

Alternatively or additionally, as in the exemplary embodiment, each member of the descriptor vector for a molecule may simply reflect the presence or absence of the key in the molecule. In this regard, the value of each member of the descriptor vector may be a binary weight (e.g., 0 or 1), and the descriptor vector may take the form of a simple bit string. This arrangement is of course useful where the descriptors themselves are not weighted. Further, this arrangement is useful where the computer maintains the weights of the keys in a separate file or table for instance so that the weights are associated by reference with the respective (non-zero) elements of each descriptor vector.

In an exemplary embodiment, the computer may require each key to appear at least a predetermined number of times in the molecule at issue in order for the key to be deemed “present” in the molecule. The predetermined number of times is a matter of design choice and may vary per key. By way of example, column 2 of FIG. 3 lists for each key a minimum number of hits that can be required in order to deem the respective key to be present in a molecule. Referring to this column for instance, exemplary key 134 is shown to have a minimum number of hits of 2 (for example), so the computer should find at least two nitrogen atoms in a molecule in order to deem the key to be present in the molecule. Of course, other values can be used instead.

An exemplary embodiment of the present invention provides a system for establishing new substructure keys to characterize features of chemical molecules and then iteratively applying these new keys to establish yet improved new substructure keys. Exemplary details of establishing new keys will be described below. These new substructure keys provide better information than the initial set of keys, principally because the new keys are advantageously derived in part from information about the molecules that they describe. For at least this reason, the computer may give preferential treatment to the learned keys when establishing descriptor vectors.

By way of example, the computer may deem as absent from a molecule any original key (i.e., a key in the initial set) that is wholly subsumed in the molecule by any new key (i.e., a key adaptively established by the computer). Thus, for instance, assume that an original key defines the chemical structure N—N and a learned key defines the chemical structure C—C—N—N. In establishing a descriptor vector for a molecule that contains the structure C—C—N—N and no other instance of the structure N—N, the computer may conclude that the structure N—N is wholly subsumed in the molecule by the learned key structure C—C—N—N, so the computer may indicate in the vector that the molecule contains the structure C—C—N—N but not the structure N—N. On the other hand, if the molecule being described includes an instance of N—N that is not wholly subsumed by the C—C—N—N, then the computer may indicate in the vector that the molecule contains the structure N—N. Further, if a key is required to appear at least a minimum specified number of times in a molecule in order to be deemed present, the computer may deem the key to be absent from the molecule if all instances key (or at least the designated minimum number of instances of the key) are wholly subsumed by any new key.

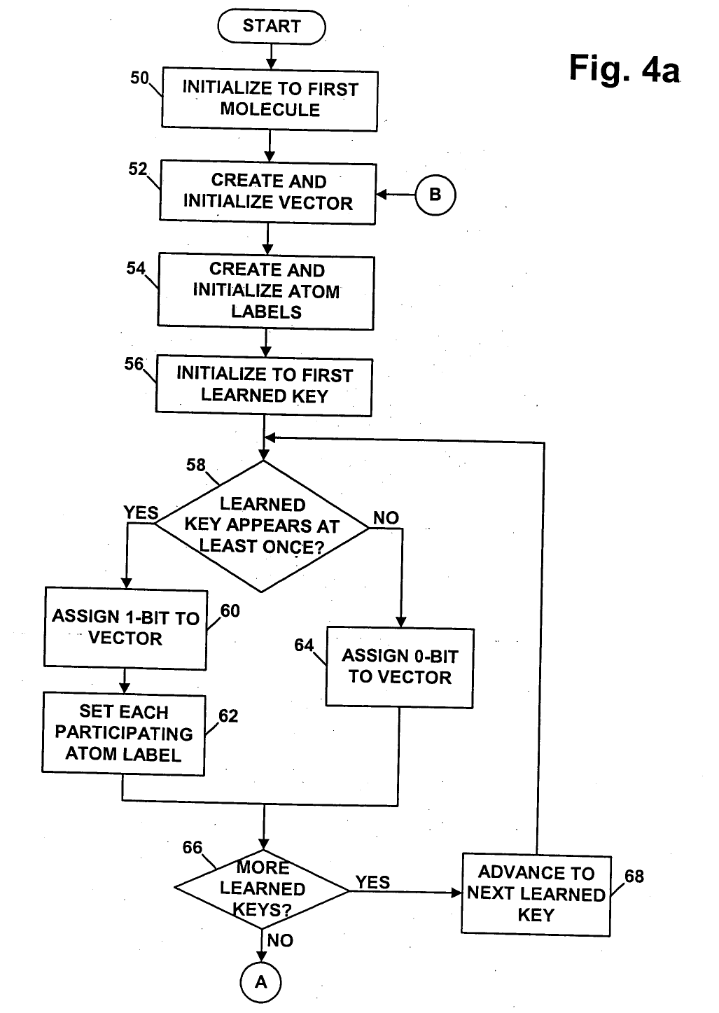

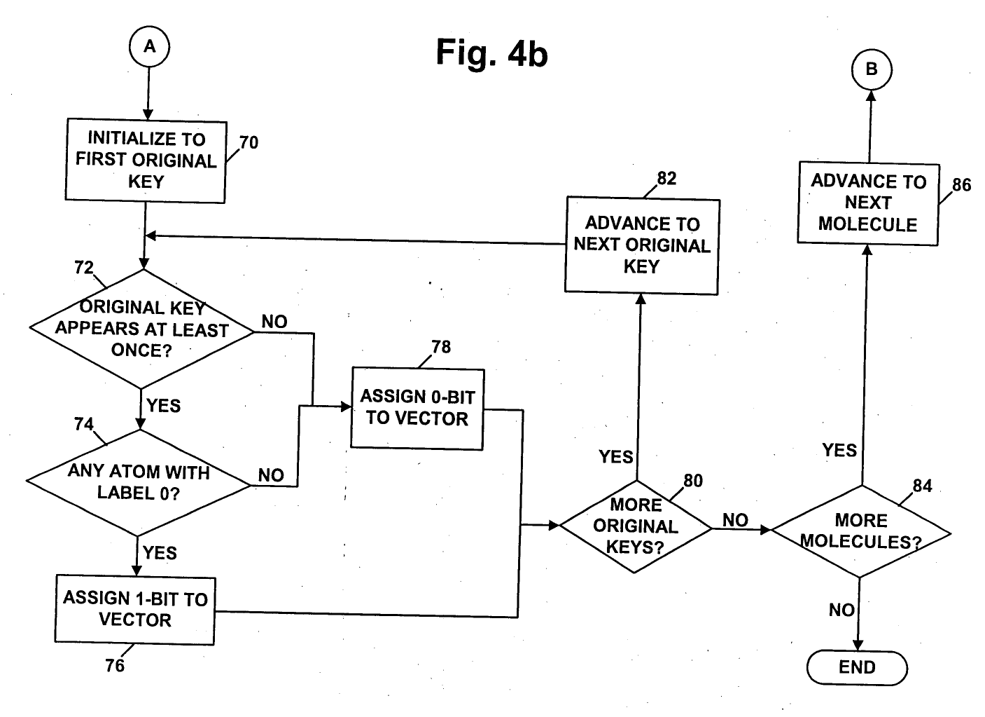

Referring to the drawings, FIG. 4 illustrates an exemplary set of functional blocks that may be involved in establishing descriptor-vectors. In this example, at block 50, the computer may initialize a pointer (e.g., counter) to the first molecule (SMILES string). For the given molecule, at block 52, the computer may create a descriptor vector of a length corresponding to the total number of keys (the number of learned keys plus the number of original keys), and initialize each member of the vector to zero. In addition, at block 54, the computer may establish a label for each component (e.g., each atom) in the molecule, which the computer will subsequently use to indicate whether the atom has participated in matching a learned substructure key, and in turn to determine whether an original substructure key is wholly subsumed in the molecule by a learned substructure key. The computer may initialize the label for each component to a value of zero, indicating that the component has not yet participated in matching a learned substructure key.

At block 56, the computer may then initialize a pointer to the first learned substructure key (SMARTS string), if any exist yet. At block 58, the computer may then search the connection table associated with the SMILES depiction of the molecule to determine whether the learned key appears at least once in the molecule. If the learned key appears at least once, then, at block 60, the computer may assign a binary 1 value to the corresponding member of vector for the molecule. Further, at block 62, the computer may set to a value of 1 the label of each component in the molecule that participated in matching the learned key. If the key does not appear at least once, then, at block 64, the computer may assign a binary 0 to the corresponding vector member. At block 66, the computer may then determine if additional learned keys exist. If so, then, at block 68, the computer may advance to the next learned key and return to block 58.

In a exemplary embodiment, once the computer has finished processing the learned key(s), the computer may then process the original keys in a similar fashion. In particular, at block 70, the computer may initialize a pointer to the first original substructure key. At block 72, the computer may then search the connection table associated with the SMILES depiction of the molecule to determine whether the original substructure key appears at least once (or, alternatively, at least a designated minimum number of times) in the molecule. If so, then, at block 74, the computer may determine whether at least one component (e.g., atom) in the molecule that participated in matching the original substructure key has a label set to 0. If so, then at block 76, the computer may assign a binary 1 value to the corresponding member of the vector. However, if the computer determines that the original key does not appear at least once (or at least the designated minimum number of times) in the molecule or that the labels for all components that participated in matching the original key are set to 1, then, at block 78 the computer may assign a binary 0 value to the corresponding vector member.

In turn, at block 80, the computer may determine whether additional original keys exist. If so, then, at block 82, the computer may advance to the next original key and return to block 72. If not, then, at block 84, the computer may determine whether additional molecules exist. If so, then, at block 86, the computer may advance to the next molecule and return to block 52. If no additional molecules exist, then the computer may conclude that it has finished establishing descriptor vectors for at least the present iteration.

Of course, variations to this and other exemplary routines described herein are possible. For instance, when establishing descriptions, the computer may deem to be absent from a molecule any substructure key that is wholly subsumed by another substructure key, rather than limiting the preferential treatment to only learned substructure keys. As another example, the computer may deem to be absent from a molecule any learned key that is wholly subsumed by another learned key (e.g., in a later iteration).

Grouping molecules. Once the computer has established descriptions of the molecules, the computer preferably identifies one or more groups of structurally similar molecules that have (i.e., that represent or exhibit) a high concentration of activity (e.g., a high percentage of active molecules). As noted above, numerous mechanisms exist to establish such correlations between structure and activity, and any of these methods may be suitably employed at this stage. In an illustrative embodiment, however, the computer may first group the molecules according to similarity of their structural descriptions and then select one or more groups of structurally similar molecules that also have a high concentration of activity. An exemplary method of grouping molecules according to their structural similarity is clustering, and more particularly 2-D SOM clustering.

The structure and operation of SOM clustering mechanisms is well known to those skilled in the art and an example is described, for instance, in T. Kohonen, Self-Organizing Maps (Springer Verlag, Berlin Heidelberg 1995, 1997), the entirety of which is hereby incorporated herein by reference. Other clustering methods suitable for use herein are also described, for instance, in Geoffrey Downs et al., “Similarity Searching and Clustering of Chemical-Structure Databases Using Molecular Property Data” (Krebs Institute, 1994), the entirety of which is also incorporated herein by reference. Still other suitable clustering mechanisms well known in the art include average-link, single link Ward's clustering, Nearest Neighbor, and K-means.

In general, SOM clustering may operate as follows. First, the computer may establish a k×k SOM grid of clusters. The choice of dimension, k, may be based on the number of molecules to be clustered as well as the desired separation between the molecules and is therefore a matter of design choice. A reasonable value of k in an exemplary embodiment is 20, thus providing 400 clusters. The computer may then randomly seed each cluster in the grid with connection weights defining a cluster template. Each of these weights is preferably a real value from 0 to 1. (The weights shown in FIG. 3 may be scaled by a factor of 100 to achieve these values.) Each cluster template is preferably a vector of a length corresponding to the total number of substructure keys used to describe the molecules, and each element of the template may correspond to one of the substructure keys. Thus, in the first iteration, where there are preferably 157 original substructure keys, each cluster template in an exemplary embodiment may be a 157 element vector.

The computer may then cycle through the descriptor vectors of the molecules at issue and places each vector into the SOM grid. The vector of the first molecule will fall into the cluster whose randomly seeded template is closest to the vector. In this regard, for instance, the computer may compute the Euclidian distances between the input descriptor vector (i.e., the vector being inserted into the grid) and each cluster template, and the computer may then assign the vector to the cluster with the shortest computed distance (representing a closest match). Each time a molecule falls into a cluster, the computer may then adjust the weights of that cluster to be closer to the weights defined by the inserted descriptor vector. For instance, if a vector defines a 1 for a particular substructure key, and the corresponding connection weight in the cluster into which the vector best fits defines a weight of 0.6 for that key, the computer may increase that connection weight in the cluster template.

The adjustment from a current cluster template connection weight to a new weight based on the weight of an input node (i.e., an input description vector) can take any form and, for example, may comprise a simple average. Alternatively, in an exemplary embodiment, the computer may adjust each connection weight in the cluster template to be a weighted average of its current weight and the input weight. In this regard, the weight change may be defined by the formula W_{new}=W_{old}+α(Wᵢₙₚᵤₜ−W_{old}), where W_{old} is the current (or old) connection weight defined by the cluster template, Xᵢₙₚᵤₜ is the weight of the corresponding node of the input data, a is a weighting factor, and W_{new} is the resulting new connection weight for the cluster template. In an exemplary embodiment, the computer may decrease a as the SOM training process proceeds, beginning at around 0.8 and progressing to a low value of 0.1. (When a is 0.5, a simple average results).

After adjusting the weights of the cluster in which the molecule fell, the computer preferably adjusts the weights of the clusters neighboring this cluster in the SOM grid. These weights are preferably adjusted to a lesser degree as the distance from the molecule's cluster increases. Thus, the more structurally similar the next molecule, the closer it will fall in the map to cluster. Ultimately, this achieves local organization or focal points in the grid, defining regions of molecules having similar features.

Each molecule is placed on the grid in this fashion, adjusting the weights of the cluster and neighboring clusters for each. Once all of the molecules have been placed on the grid, they are removed and the process is repeated, refining the connection weights learned in the first pass. By repeating the clustering process over many iterations (on the order of 100s or 1000s for instance), the SOM grid ultimately becomes stable, learning to associate cluster templates with molecules based on the importance (weights) of features to particular clusters in the grid.

Training of the SOM grid is preferably complete when every molecule in a current iteration falls in the same cluster as in the last iteration. After training is complete, the nodes of the SOM grid are defined by a weighted descriptor vector (template) with trained weights. The structural keys corresponding to each highly-weighted bit in a cluster's feature vector are then important dimensions of structural similarity for the molecules in the node. (In particular, if many molecules that fit within the cluster have a particular substructure key in common, the connection weight associated with the substructure key will approach a binary 1 or the weight of the particular key.)

SOM clustering does not necessarily establish what makes molecules active but rather what substructure features the molecules have in common. It is reasonable to assume initially, however, that this structural similarity may relate to a common activity characteristic represented by a given cluster, particularly when a high concentration of active molecules fall within the cluster. In other words, the computer may use the SOM clustering process to discover correlations between structure and activity.

A training set of the molecules at issue is used to train the SOM network. This training set could be all or a subset of the molecules under analysis. In an exemplary embodiment, the training set is all of the active molecules in the input data set, and none of the inactive molecules. A molecule may be deemed to be active for this purpose according to any desired criteria. By way of example, a molecule may be deemed to be active if its activity level exceeds some predetermined level or is non-zero. As another example, if the activity characteristic of each molecule is multi-dimensional, then a molecule may be deemed to be active if the molecule is active with respect to each of a set of assays (various dimensions of the activity characteristic). In other words, a molecule may be deemed to be active if the molecule has some desired set of activity characteristics in a multi-dimensional representation of active (for example, active along all dimensions or active along some dimensions and inactive along others, etc).

This training set of active molecules advantageously enables the computer to learn what makes the active molecules similar. The inactive molecules could then be used subsequently for testing. Alternatively, the training set can be a subset of the active molecules, and the remaining active molecules could be used subsequently for testing. Still alternatively, any other training set can be used.

Identifying Hot-Spots. In this stage, according to an exemplary embodiment, the computer evaluates the SAR per cluster and/or per neighborhood of clusters by considering the activity of the molecules in a given cluster or group of clusters. The object at this point is to identify areas or hot spots in the SOM grid that represent or exhibit a high concentration of activity (based on the activity level of the molecules in the area), which can reasonably be correlated with the structural similarity of the molecules in the identified area. Since training the SOM grid achieves localized organization of molecules based on their structural similarity, some areas of the grid may have a high concentration of active molecules and others may have low concentration. Some clusters may contain many active molecules, others may contain few active molecules, and still others may contain no active molecules at all. In identifying hot spots, the computer preferably looks for areas of high concentration of activity.

At this stage, the SOM map has already become stable, and its clusters are each represented by a template/vector indicating weights (or binary value) for each possible substructure key. It is no longer training. The computer may now evaluate structure-to-activity relationships, for example, by considering the activity levels of the molecules in each cluster. Thus, for example, the computer may cycle through the clusters in the SOM grid and determine how many active molecules are in each cluster and/or calculate the average activity level of the molecules in the cluster. In turn, if the number of active molecules or the average activity level of the molecules exceeds a predetermined threshold level, then the computer may select the cluster as a hot spot.

Further, the computer may extend this exemplary analysis to wider areas of the SOM grid. For instance, if a neighborhood of several adjacent clusters contains a relatively large number of active molecules compared to other areas, the computer may reasonably conclude that the structural similarity defined by the neighborhood is correlated with the high activity of the molecules in the neighborhood. Therefore, the computer may designate the neighborhood as a hot spot.

In an exemplary embodiment, the SOM grid is trained with active molecules only. In that context, the computer may for example identify as a hot spot (or as the core of a hot spot) any cluster that contains at least two active molecules (hereafter a non-singleton cluster). Additionally, the computer may take into consideration the relative levels of activity, weighing more heavily higher levels of activity in determining whether an area in the grid should constitute a hot spot.

Further, in order to best evaluate structure-activity relationships defined by the trained SOM grid, the computer preferably applies a set of test data to the SOM grid and then evaluates the contents of the clusters. The test data is preferably some independent data that was not used to train the SOM grid. For instance, if the SOM grid is trained by all of the active molecules as in an exemplary embodiment, then the test data may be some or all of the inactive molecules. The computer may fit each inactive molecule into the cluster whose template the descriptor vector of the inactive molecule most closely matches.

If the SOM grid has been trained with both active and inactive molecules and/or has been trained with active molecules and then tested with inactive molecules, then the computer may employ still other criteria for selecting hot spots. For instance, the computer may exclude as a hot spot any cluster that contains one or more inactive molecules, since it is reasonable to conclude that the structural similarity of molecules in such a cluster does not relate to the activity of the molecules. Similarly, the computer may be programmed to select a cluster as a hot spot only if the cluster contains at least a predetermined threshold percentage of active molecules.

Of course, the computer may employ some or all of the foregoing and/or other criteria as desired to select one or more suitable hot spots that appear to correlate structure with activity. The goal at this point should be to increase the odds of learning a useful new substructure key in the next stage. Thus for example, and without limitation, the computer may rank a set of potential hot spots according to average activity level and may then select only a predetermined number or percentage of the potential hot spots that have highest average activity levels.

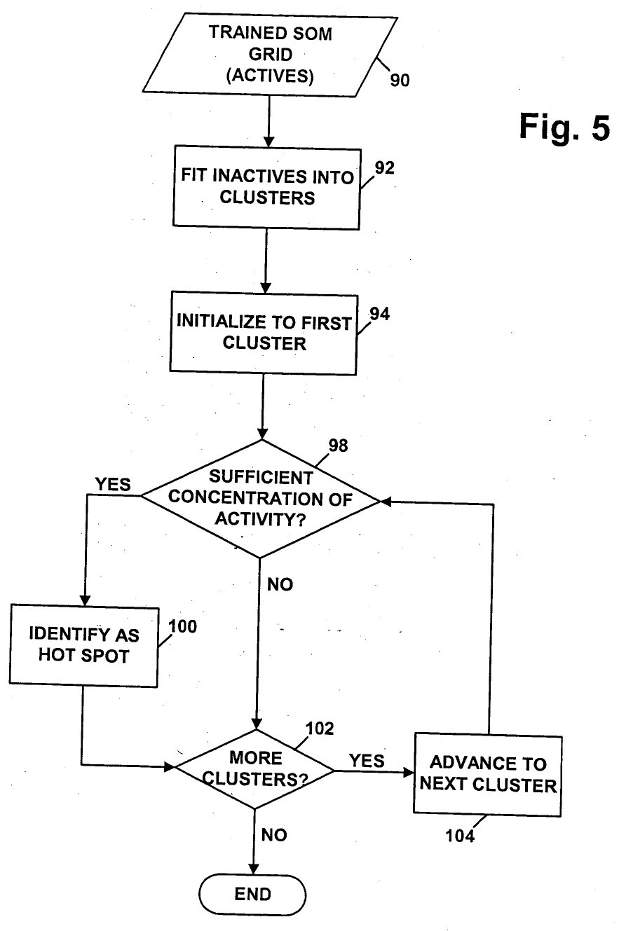

Referring to the drawings, FIG. 5 illustrates a set of functional blocks that may be employed in identifying hot spots according to an exemplary embodiment. As shown in FIG. 5, at block 90, the computer begins with a trained SOM grid, which, in an exemplary embodiment, was trained with only active molecules. At block 92, the computer may fit each of the inactive molecules into the cluster of the SOM grid whose template the descriptor vector of the molecule most closely matches. At block 94, the computer may initialize a pointer to the first cluster, to facilitate cycling through the clusters.

At block 98, the computer may determine whether the cluster exhibits or represents a sufficient concentration of activity. This decision may involve determining whether the cluster contains more than J active molecules and less than L inactive molecules. Both J and L are preferably adjustable parameters and are therefore matters of design choice. The choice of a value for J may be based on the diversity of the molecules in the data set and the size of the SOM grid. (For instance, J may be higher (e.g., 10) for highly similar sets of molecules being clustered, as in a very focussed screening data set, and J may be lower (e.g., 2) for larger, more diverse sets.) The choice of a value of L may be based on an estimated error rate in the assessment of the activity of the molecules in the data set. In an exemplary embodiment, by way of example, the value for J is 4, and the value for L is 1 (the latter requiring that no inactive molecules fall within the cluster).

If the computer determines that the cluster represents a sufficient concentration of activity, then, at block 100, the computer may designate the cluster as a hot spot. In turn, at block 102, the computer may determine whether more clusters exist in the SOM grid. If so, then, at block 104, the computer may advance to the next cluster and return to block 98 to evaluate the structure-activity relationship of the cluster.

In an exemplary embodiment, each hot spot has a discriminating set of features that defines the similarity of molecules in the hot spot. As an example, where the hot spot is a single cluster, the discriminating set of features may be defined by the substructure keys of the cluster template, to which the molecules in the cluster most closely match. As another example, where the hot spot is a neighborhood of clusters, the discriminating set of features may be defined by some function of the cluster templates of the various clusters in the neighborhood. For instance, the discriminating set of features may be an average of the cluster templates or the union of the cluster templates or some other function.

Further, the discriminating set of features may for example exclude any substructure keys that are not present in the hot spot (for instance, any substructure keys that have a binary 0 value in the cluster template for a cluster defining the hot spot) or that have less than some threshold weight or relative weight. The computer may reasonably conclude that such substructure keys are not responsible for structural similarity of the molecules in the hot spot and therefore do not distinguish or define the hot spot.

Learning New Substructure Keys. In an exemplary embodiment, once the computer has selected one or more hot spots, the computer may actively map the discriminating features of each hot spot back to the molecules in the hot spot so as to discover what the clustering learned. That is, the computer may discover the most significant structural similarity (or similarities) in each hot spot. This significant structural similarity may be deemed to be at least a potential new learned key.

The idea here is to build a composite structure of components (e.g., atoms, bonds and/or other features) that best represents the structural similarities of the molecules in a hot spot and that, therefore, most likely correlates with the observed activity of the molecules. In an exemplary embodiment, this composite structure is not just the similar substructure keys in the molecules of a given hot spot. Rather, because the exemplary embodiment is particularly interested in chemical reactions, the process of learning the composite structure may preferably take into consideration where in the molecules the substructure keys fired or, in other words, what components of the molecules caused the substructure keys to fire.

For instance, several molecules in a hot spot may have several keys in their descriptor vectors in common, but these keys might not be set by the same substructure in all the molecules. In that case, the computer may reasonably conclude that there is no composite structure of interest in all of the molecules. However, if the computer determines that a significant set of keys common to all the molecules in the hot spot are set by matching a larger composite substructure that appears in a relatively large number of molecules in the hot spot, then the computer may reasonably conclude that the composite structure is of particular interest.

The result of clustering with descriptor vectors that are based on MACCS-like keys (e.g., SMARTS strings) is clusters of molecules with somewhat similar structures. However, the MACCS-like keys are unable to differentiate between structurally dissimilar molecules that set the same keys in the descriptor vector. This happens quite often because the keys are “redundant,” describing small substructures of the molecule with multiple keys. A more representative feature of the molecules is the maximum common substructure (MCS) that is contained in all of the molecules in a hot spot (i.e., the largest contiguous subgraph common to all the molecules (graphs)). Therefore, in accordance with an exemplary embodiment, a computer should seek to find the MCS among the molecules within each hot spot. If the computer finds a most common composite structural component in a hot spot, the computer may reasonably conclude that the structure is correlated with (or responsible for) the structural categorization of the molecules. Therefore, the computer may select the MCS (or some fraction of the MCS) as a new key. In addition or alternatively, the computer may derive new keys from other common substructures (non-MCS) in the molecules that define the hot spot.

In an exemplary embodiment, the computer may identify an MCS among a set of molecules by employing subgraph isomorphism, which is a technique well known to those skilled in the art. A goal of the exemplary embodiment, however, is to generate pharmacophorically “interesting” or “useful” structural information. Therefore, instead of searching for merely the maximum common substructure among the molecules, the computer may beneficially look for the maximum pharmacophorically important common substructure (i.e., a pharmacophorically important MCS) among the molecules. To accomplish this, as presently contemplated, the computer may take advantage of the redundancy inherent in the keys, using the redundancy as a way to identify what parts of the molecules in the hot spot define the similarity in the key dimensions.

As noted above, each of the substructure keys employed by the computer (e.g., received as input data) may be weighted. Alternatively, each key may be assigned a binary weight of 1, such that all keys have the same weight. According to an exemplary embodiment, the computer may weigh the atoms (and/or bonds and/or other features) in the molecules of the hot spot with the sum of the weights of every key whose “hit” involves that atom. In this way, the computer can see the relative “importance” of each atom to the similarity that defines each hot spot and use this information to drive the discovery of the pharmacophorically important MCS.

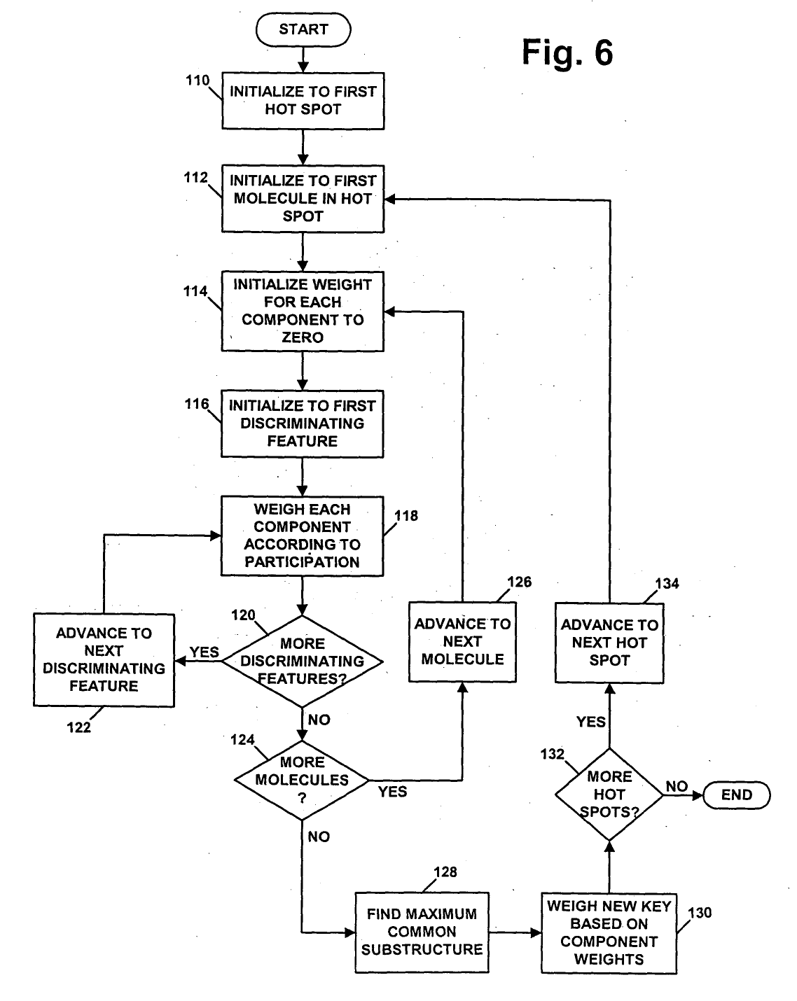

FIG. 6 depicts an illustrative set of functional blocks that may be involved in learning new keys according to this aspect of an exemplary embodiment. Referring to FIG. 6, at block 110, the computer may first initialize a pointer to the first hot spot. For the given hot spot, at block 112, the computer may further initialize a pointer to the first molecule in the hot spot. At block 114, the computer may then establish a weight for each component in the molecule and initialize the weight to zero. In an exemplary embodiment, the computer considers and weighs only atoms (although the computer could consider other components or aspects of the molecules as well). At block 116, the computer may then initialize a pointer to the first of the substructure keys or other indicia that defines the discriminating features of the hot spot.

At block 118, the computer may then weigh or “score” the atoms within each of the molecules in the hot spot by the number of times that they participate in matching the substructure key. In this regard, the computer may look for “hits” or instances where a substructure key appears in the molecule. For each such hit, the computer may add the weight of the substructure key to the weight of each of the atom(s) that the key hit. Thus, for instance, if the substructure key C—N has a weight of 0.7 and the key hits in a given molecule, the computer may add the weight 0.7 to the weight of the subject carbon atom and nitrogen atom in the molecule. Alternatively, for instance, if the C—N key has a binary weight of 1, then the computer may increment the weights of each of the two atoms by a value of 1. This increase in weights thus reflects participation of those atoms in defining the structural similarity of the molecules in the hot spot.

At block 120, the computer may next determine whether additional discriminating features exist for the hot spot. If so, then, at block 122, the computer may increment to the next discriminating feature and return to block 118. If not, then, at block 124, the computer may determine whether additional molecules exist in the hot spot. If so, then, at block 126, the computer may increment to the next molecule and returns to block 114.

In an exemplary embodiment, at block 128, once the computer has scored the participating atoms of the molecules in the hot spot, the computer may analyze the molecules in an effort to identify and select a maximum common substructure of all of the molecules in the hot spot. The computer may employ any suitable method to identify maximum common substructures. By way of example and without limitation, the computer may employ a genetic algorithm to compare the molecules and to identify a largest common substructure.

In an exemplary embodiment, the maximum common substructure (MCS) should be a contiguous common substructure among the molecules in the hot spot. However, the common substructure may alternatively be a non-contiguous structure. Further, in addition to or instead of finding the maximum common substructure, the computer may seek to find any common substructure(s) among the molecules (i.e., whether or not contiguous). The computer may deem the common substructure (and preferably the MCS) to be a reason for the structural similarity of the molecules that define the hot spot. Therefore, the computer may select each such common substructure as a new key and/or pharmacophore.

In an exemplary embodiment, the computer may render its comparison of molecules more efficient by first deleting from a stored representation of each molecule any atom that has scored less than a threshold value (such as the median weight of all atoms in the molecule for instance). The computer then preferably applies a genetic algorithm to find at least the MCS of the remaining molecular structures. An example of a suitable genetic algorithm is a modified version of that described in “Matching Two-Dimensional Chemical Graphs Using Genetic Algorithms,” Robert D. Brown, Gareth Jones, and Peter Willett, J. Chem. Inf. Comput. Sci., 1994, 34, 63-70. The entirety of the Brown et al. reference is hereby incorporated by reference. The Brown reference describes how to use a genetic algorithm to generate the maximum common substructures between two molecules. As presently envisioned, by way of example, the Brown algorithm can be modified in several respects.

First, the Brown algorithm may be modified to establish the maximum common substructure between possibly more than two molecules (as a hot spot may contain more than two molecules). In this regard, when the computer compares two molecules, the computer may maintain a record of all potentially matching substructures (rather than identifying only the maximum common substructure). The computer may then use these potentially matching substructures when comparing the match between the two molecules to a third molecule. For example, the computer may generate all potential common substructures when comparing the first two molecules and then restrict its comparison to the third molecule to these potential common substructures. The computer may continue this procedure until it has completely analyzed all of the molecules. Once all of the molecules in a group have been analyzed, the computer may then conclude that the largest common substructure remaining is the maximum common substructure of this group of molecules.

Second, the computer may assign weights to atoms of the individual molecules and use these weights in the fitness function of the genetic algorithm. For example, assume that four given keys such as MACCS keys all hit an atom A1 in the first molecule and also all hit an atom A2 in a second molecule. Assume further that another atom A3 in the second molecule is hit twice by only two of the four keys. Therefore, the difference between the weights of atoms A1 and A2 is less than the difference between the weights of atoms A1 and A3. In this example, based on the atom weights, the fitness function may consider atoms A1 and A2 to be a better match than atoms A1 and A3. Thus, the computer may update the fitness value to reflect the match between A1 and A2. In this way, the keysets used to differentiate the molecules can be used to guide/bias the genetic algorithm's procedure for choosing which two atoms should be matched when there are a number of potential matches, thereby allowing it to potentially converge faster.

Still further, the computer may use the weights to reduce the number of matches that need to be searched in the genetic algorithm to determine a set of atom matches between two compounds. For instance, in the preceding example, the computer may consider atoms A1 and A2 to be a potential match, while the computer may determine that atoms A1 and A3 are above a weight difference threshold and therefore are not a valid match. Because of the threshold, the number of potential matches to be considered in finding the MCS is reduced. Reducing the search space for the genetic algorithm in this way allows it to potentially converge more quickly.

In the exemplary embodiment, an illustrative fitness function for comparing two molecules may operate as follows. First, the computer may define the maximum allowable difference (MAD) to be 20% of the weight on an atom. Second, the computer may define DIFF to be the absolute value of the difference between the weight on an atom in one molecule and the weight on an atom in the other molecule. In turn, the computer may determine whether DIFF is greater than MAD. If so, then the computer may conclude that the atoms do not match. If not, the computer may adjust the fitness value via the following formula:

New fitness=Old fitness+10.0*(MAD−DIFF)/MAD.

Of course, the foregoing provides only an example of a genetic algorithm for use in identifying maximum common substructures. Suitable variations and/or other algorithms may exist as well.

In an exemplary embodiment, at block 130, the computer may weigh each new substructure key based on the weights of its components. As an example, without limitation, the computer may set the weight of the new substructure key equal to the average weight of the atoms (or other components) that make up the learned key. For instance, the computer may set the weight of the new substructure key equal to the average weight of the atoms (or other components) that make up the substructure matched by the learned key in each of the molecules in the cluster (or other hot spot). In this example, the computer may take the average over all the atoms in all of the matching substructures in all of the molecules. Alternatively, for instance, the computer may select one molecule (or a subset of molecules) in which the learned key hits (with no particular preference to which molecule, for instance), and the computer may take the average of the atoms in that matching substructure. As with the weights established for the original keys, a purpose of assigning weights to newly learned keys is to establish the relative importance of the new keys in describing two molecules as similar.

In turn, at block 132, the computer may determine whether more hot spots exist in the SOM grid. If so, then, at block 134, the computer may advance to the next hot spot and return to block 112. If not, then the computer may conclude that it has finished identifying potential new keys.

Confirming New Keys. In an exemplary embodiment, the computer may seek to confirm the efficacy of each potential key that it has learned in the current iteration. The computer may do so as it learns the potential keys or once it has learned all of the potential new keys or at some other desired time. The computer may employ any desired criteria to confirm a new key. By way of example and without limitation, the computer may seek to determine whether the same key exists in the molecules of neighboring clusters. This function is particularly useful if the hot spot is limited to a single cluster, since the computer may verify the efficacy of the learned key by reference to close and therefore structurally similar clusters. Of course, if the hot spot is more broadly a neighborhood of clusters having a high activity concentration, then this function may be of little additional help, since the process of learning the new key has already taken into consideration neighboring clusters of interest. As other examples, the computer may reject a potential new key if the key is redundant or is a subset or superset of an existing key.

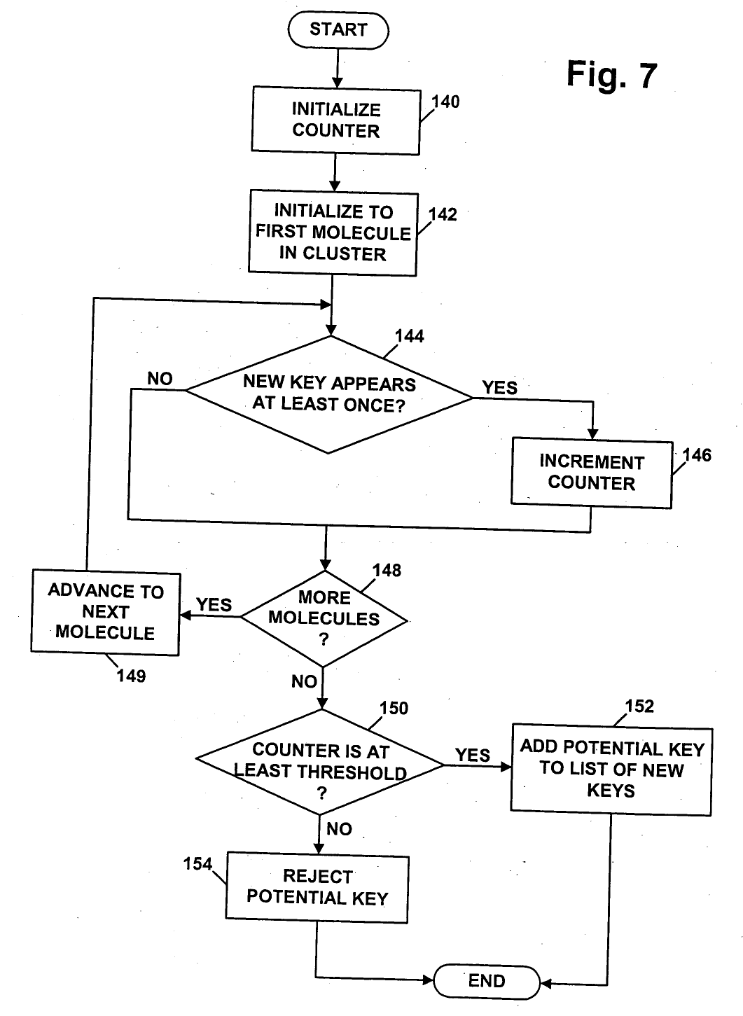

FIG. 7 illustrates a set of functional blocks that may be involved in confirming a potential new key according to an exemplary embodiment. In this example, it is assumed that the hot spot from which the potential new key evolved is a single cluster, and that neighboring clusters in the SOM grid are six clusters adjacent to the hot spot cluster, including two above, one to the left, one to the right, and two below.

As shown in FIG. 7, at block 140, the computer may first initialize a counter i to zero. The computer may then consider each of the neighboring clusters in turn. For each neighboring cluster, at block 142, the computer may initialize a pointer to the first molecule in the cluster. At block 144, the computer may then search the connection table associated with the SMILES depiction of the molecule to determine whether the potential new key appears at least once in the molecule. If so, then, at block 146, the computer may increment the counter i by 1. At block 148, the computer may then determine if additional molecules exist in the neighboring cluster. If so, then the computer may advance to next molecule and return to block 144.

Upon considering the neighboring clusters, if the counter i is at least a predetermined threshold count, then, at block 150, the computer may conclude that the potential learned key is confirmed. Accordingly, at block 152, the computer may add the potential new key to a list of learned keys for use in subsequent iterations (and/or for possible output as a pharmacophore). On the other hand, if the counter i is less than the threshold count, then, at block 154, the computer may conclude that the key does not define an interesting (or interesting enough) structure-activity relationship, and the computer may therefore reject the potential new key.

The threshold count is a matter of design choice, which may depend on various factors, such as the diversity of the data set being analyzed, and whether the desire is to learn coarse or fine grained discriminations between sets of active molecules. For instance, for highly similar sets of molecules (as in a very focussed screening data set), the threshold count may be 0 for example, such that the potential new key need not appear in any adjacent clusters. On the other hand, for larger, more diverse data sets, more coarse criteria may be desirable. In that case, the threshold count may be 10 for example, such that the potential new key must appear in at least 10 molecules of adjacent clusters in order to be confirmed. In an exemplary embodiment, the threshold count is 2, such that the potential new key must appear in at least two molecules of adjacent clusters in order to be confirmed.

The number of new keys learned and confirmed in each iteration is also a matter of design choice. If the computer seeks only a MCS from each hot spot, and each hot spot is a single cluster, then the upper limit of new keys learned in each iteration is the number of clusters in the SOM grid, or 200 in the exemplary embodiment. Practically speaking, however, no more than about 10% to 30% of the clusters in the map will result in newly learned keys.

Iterating. In an exemplary embodiment, once the computer has learned (and preferably confirmed) one or more new keys, the computer may repeat the process, beginning at block 34 in FIG. 2. The computer may repeat the process for a predetermined number of iterations. In an exemplary embodiment, by way of example, the computer performs only four iterations and then stops. Alternatively, the computer may not iterate at all, thus stopping after learning one or more new keys.

Alternatively, the computer may repeat the process until the computer determines that it will not learn useful new keys in additional iterations. The computer may employ any criteria to determine when to terminate the iterative process. By way of example, the computer may compare the average size of the most recently learned keys (e.g., the average number of atoms in the most recently learned keys) to the average size of the molecules in the data set (e.g., the average number of atoms in the molecules in the data set). If the average size of the most recently learned keys is a large fraction of the average size of the molecules (e.g., ½), then the computer may terminate the iterative process.

As another example, the computer may evaluate the number of original keys that continue to describe the molecules in the data set after the learned keys are matched with the data set. If only a small fraction of original keys are not wholly subsumed by the learned keys, then the computer may terminate the iterative process. Of course, other examples may exist as well.

Assessing the Learned Substructure Keys from the Previous Iteration. In accordance with an exemplary embodiment, the computer may assess the performance of each substructure key learned in a previous iteration. The object here is to confirm that a new key learned in one iteration is effective in separating active compounds from inactive compounds in the next iteration. If not, then the computer may conclude that the learned key is not of interest, and the computer may “un-learn” the new key, by removing it from the list of new keys.

The computer may employ any desired method to assess the performance of keys learned in the previous iteration. An exemplary method may operate as follows for each substructure key learned in the previous iteration. The computer may begin with the SOM grid trained (and possibly tested) in the present iteration. The computer may then identify all of the molecules (both active and inactive) that the previously learned key hit, or, in other words, all of the molecules in which the substructure defined by the previously learned key appears. The computer may then compare the number of inactive molecules hit by the substructure to the number of active molecules hit by the substructure. In an exemplary embodiment, if the number of inactive molecules is more than twice the number of active molecules, then the computer may discard the previously learned substructure key.

Reducing the Weight of Substructure Keys Learned in Previous Iterations. In an exemplary embodiment, learned keys may remain in the set of learned keys for any and all subsequent iterations. However, in order to underscore the importance of more recently learned keys, the computer preferably reduces the weight of every previously learned key (if any) by a predetermined fraction in each subsequent iteration. In this way, newer learned keys (which tend to be larger than previously learned keys) can have proportionately higher weights than previously learned keys. In an exemplary embodiment, the predetermined fraction of reduction, if employed, may be ½. However, the fraction may be any desired value (including, for instance, 1, to indicate no reduction).

Outputting Data In an exemplary embodiment, the computer may output data providing information that it has gleaned from the input data set in accordance with the present invention. The output data may convey various desired information. By way of example, the computer may output data representing as a pharmacophore the largest new key (e.g., with the most atoms) that the computer has learned from the data set. In this regard, for instance, the computer may present the pharmacophore to a user (e.g., a chemist) in any manner. For example, the computer may provide a data file or screen display of the SMART string representation of the pharmacophore and/or a diagram representing the chemical structure of the pharmacophore. As an optimized lead, the pharmacophore may itself be commercially valuable in the drug development industry or suggest other compounds containing the pharmacophore that are commercially valuable.

As another example, the computer may output data representing others or all of the new keys that the computer has learned from the data set, possibly indicating the sequence in which the computer generated the new keys. Each of the new keys may itself constitute a valuable pharmacophore. Further, the set of new keys, perhaps together with the set of original keys, may be usefully employed by a computer, chemist and/or drug development company to describe, analyze and/or identify other molecules that are commercially valuable.

As yet another example, the computer may output a set of data indicating the cluster templates of all clusters in the trained SOM grid of the final iteration, and the molecules (e.g., their SMARTS strings and their respective activity characteristics) contained in each cluster (or other group) in the final iteration. The computer may present this information to a user in any manner. For instance, the computer may output a data file that lists clusters (numbered 1 to 400 in an exemplary embodiment), indicates the cluster template, and lists the molecules (e.g., SMART strings) in each cluster. The computer may indicate for each molecule its respective activity level and the computer may provide a measure of average activity level or activity concentration for the cluster as a whole.

Alternatively or additionally, the computer may output a screen display that depicts the SOM grid, illustrating in each cluster the number or percent of active and inactive molecules. The computer may code each cluster by a color or brightness that represents the relative activity concentration of the cluster (e.g., average activity level of the molecules in the cluster). The computer may then be programmed to allow a user to select a cluster for more information. For instance, upon selection of a cluster, the computer may display an indication of the cluster template and a list of the molecules in the cluster. Further, the computer may be programmed to allow a user to select a molecule for more information. For instance, upon selection of a molecule, the computer may display a diagram of the molecular structure.

Advantageously, the final SOM grid, in cooperation with the enhanced set of substructure keys established by the present invention (i.e., original and learned keys), could be used in practice to virtually screen molecules that have unknown activity. For example, a computer could establish a descriptor vector for a test molecule and then fit the test molecule into the cluster whose template the descriptor vector most closely matches. The computer may then conclude that the test molecule is likely to have an activity similar to the average activity level of other molecules in the cluster. This virtual screening process may improve over the virtual screening that would be possible with only the original set of keys, since the learned keys are preferably based on information about a specific assay (or assays) as described above.

Still further, the final cluster-by-cluster classifications of molecules can be used to advantageously to facilitate a selection of training sets for pharmacophore model building software. Such software typically requires that the input molecules are all active at the same protein site. With the input molecules, pharmacophore model building software finds an alignment of one possible three-dimensional structure for each input molecule that places defined features in each molecule in the same three-dimensional arrangement. This common three-dimensional arrangement of features is proposed by the software as a possible pharmacophore model defining the points at which the molecules interact with the protein site. (One of many examples of this software is DISCO, sold by Tripos Inc. DISCO is described in the technical literature by the developers in the Journal of Computer-Aided Molecular Design, volume 7, pages 83-102, published in 1993.) As presently envisioned, a computer can select or identify one of the final clusters that has a high concentration of activity. In view of the structural similarity of the molecules established through the iterative clustering and key learning process, it is reasonable to conclude that the molecules in the cluster are all active at the same protein site. Thus, representatives or a subset of the cluster of molecules may be appropriate as input for pharmacophore model building software.

C. Exemplary Pseudo-Code

Although the foregoing description of an exemplary embodiment will enable a person of ordinary skill in the art to readily make and use the invention, the following exemplary pseudo-code listing is provided for additional understanding. In this pseudo-code listing, the number of molecules in an exemplary data set is n, the number of original keys is m, the number of learned keys is t, and each key is weighted with a value of 1.

1. Create a Feature Vector Describing Each Molecule

For every molecule in the data set, molecule_{y}, where y increments from 1 to n:

Initially create a feature vector of length m+t, so that there is one bit for each of the keys that will be used to describe the molecule. Initially set the value of each bit to be O.

Establish a label A for each atom in molecule_{y}. Initially set the label A to be O.

For every learned substructure key, learned_keyₓ, where x increments from 1 to t, if any:

Search the Daylight SMILES representation of molecule_{y} with the Daylight SMARTS representation of the learned key, learned_keyₓ.

If learned_keyₓ is found at least once in molecule_{y}, then set the bit m+x in the feature vector to be 1.

Change the label A of each atom in molecule_{y} that participated in matching the learned substructure learned_keyₓ to be 1.

End of for every learned substructure key, learned_keyₓ.

For every original substructure key, original_key_{z}, where z increments from 1 to m:

Search the Daylight SMILES representation of molecule_{y} with the Daylight SMARTS representation of the original_key_{z}.

Identify the atoms in molecule_{y} that participated in matching original_key_{z}.

If the original_key_{z} is found at least once in molecule_{y} and at least one atom that participated in matching the original_key_{z} has a label A equal to O, then set the bit z in the feature vector to be 1.

End for all substructure keys, original_key_{z}.

End for all molecules.

2. Clustering the Molecules with Self Organizing Maps

Using the feature vector describing each molecule, cluster the active molecules of the data set in a k by k self organizing map, to establish a trained self organizing map.

3. Identify Hotspots in the Self Organizing Maps

Initialize a count of hot spot clusters, p, to 0.

For each of the inactive molecules of the dataset:

Place the inactive molecule in the cluster of the trained self organizing map whose feature vector most closely matches the feature vector describing the inactive molecule.

End for each inactive molecule in the dataset.

For each cluster in the trained self organizing map:

If the cluster contains more than J (e.g., 4) active molecules and the cluster contains fewer than L (e.g., 1) inactive molecules, then identify this cluster as a hotspot and increase the count of hotspot clusters, p, by 1.

End for each cluster in the self organizing map

4. Learning New Keys

For each of the clusters identified as hotspots, cluster_{q}, where Q runs from 1 to p:

For each of the molecules in the hotspot cluster_{q}:

Establish a weight, B, for each atom in the molecule and initially set the weight to O.

For each of the keys learned by the SOM that defines the similarity between the molecules in the cluster:

Find the atoms in molecule that match the key and increment the weight, B, on these atoms by the weight on the key (i.e., by 1 in the current example).

End for each of the keys defining the cluster.

End for each of the molecules in cluster_{q}

Apply a genetic algorithm to find the maximum common substructure of all the molecules in the hotspot cluster using only the atoms in each molecule with a weight greater than or equal to the median weight of the atoms in that molecule.

Designate the maximum common substructure as a proposed new substructure key, and add to a list of proposed new substructure keys.

Assign to the proposed substructure new key a weight that is the average of the weights on the atoms that make up the key.

End for each of the clusters, cluster_{q}, identified as a hotspot.

5. Testing a Proposed New Substructure Key

For each of the proposed new substructure keys:

Initialize a counter, i, to 0.

For each of the six neighboring clusters of the hotspot cluster from which the proposed new substructure key was learned (two above, one to the left, one to the right, and two below):

For each of the molecules in the neighboring cluster, if any:

Search the Daylight SMILES representation of the molecule with the Daylight SMARTS representation of the proposed new substructure learned key.

If the proposed new substructure key is found, increment the counter, i, by 1.

End for each of the molecules in the neighboring cluster.

End for each of the neighboring clusters

If the counter i is at least K (e.g., 2), then designate the proposed new substructure key as a confirmed new substructure key, and add to a list of confirmed new substructure keys.

End for each of the proposed new substructure keys.

Increase t by the number of confirmed new substructure keys.

6. Assessing the Learned Substructure Keys From the Last Iteration

For each of the substructure keys learned and confirmed in the previous iteration:

Identify all of the molecules (active and inactive) that the learned substructure key hit in the current iteration.

If the number of inactive molecules hit by this substructure key is more than twice the number of active molecules hit, discard the learned substructure key.

End of for each substructure key identified in the previous iteration.

7. Reducing the Weight of the Learned Substructure Keys From all the Previous Iterations

For all the substructure keys learned in all the previous iterations, if any:

Reduce the weight of this learned substructure key to one half its current weight.

End for all the substructure keys from the previous iterations.

8. Iterate

Repeat the process, starting at step 1. Perform a total of 4 iterations in the current example.

### d. CONCLUSION

An exemplary embodiment of the present invention has been described herein. It will be understood, however, that changes and modifications may be made thereto without deviating from the true spirit and scope of the invention as defined by the claims. For instance, where appropriate, individual elements described herein may be substituted with other equivalent elements now known or later developed. All examples described herein are illustrative and not necessarily limiting.

Further, the claims should not be read as limited to the described order of elements unless stated to that effect. In addition, use of the term “means” in any claim is intended to invoke 35 U.S.C. §112, paragraph 6, and any claim without the word “means” is not so intended.

We claim:

1. A computerized method of producing a mechanism model based on features and responses of a set of data objects, said computerized method comprising:
establishing a description of each data object, based on a comparison between a set of features of the data objects and a set of descriptors;
selecting a group of data objects that have similar descriptions and that cooperatively exhibit a particular response characteristic;
establishing said mechanism model based on commonality of features among the data objects in the selected group; and
outputting data indicative of said mechanism model.

2. A computerized method of producing a mechanism model based on features and response characteristics of a set of data objects, said computerized method comprising:
establishing a description of each data object, based on a comparison between a set of features of the data objects and a set of descriptors;
selecting at least one group of data objects that have similar descriptions and that cooperatively exhibit a particular response characteristic, said group of data objects having a set of discriminating features defining similarity of the data objects in said group;
identifying at least one common subset of features of the data objects in said group based at least in part on a measure of how much said at least one common subset of features participated in defining the discriminating features of said group; and
outputting said at least one common subset of features as a mechanism model.

3. A computerized method as claimed in claim 2, wherein selecting at least one group of data objects that have similar descriptions and that cooperatively exhibit a particular response characteristic comprises:
grouping the data objects based on similarity of their respective descriptions, so as to produce groups of data objects; and
selecting at least one of said groups of data objects that contains data objects having said particular response characteristic.

4. A computerized method as claimed in claim 3, wherein the selected group contains at least a predetermined number of data objects having said particular response characteristic.

5. A computerized method as claimed in claim 3, wherein the selected group contains at least a predetermined percent of data objects with said particular response characteristic.

6. A computerized method as claimed in claim 3, wherein grouping the data objects based on similarity of their respective descriptions comprises clustering said data objects.

7. A computerized method as claimed in claim 3, wherein clustering said data objects comprises applying a self-organizing-map keyed to said descriptors.

8. A computerized method as claimed in claim 2, wherein selecting at least one group of data objects comprises grouping the data objects based on both their respective descriptions and their respective response characteristics.

9. A computerized method as claimed in claim 8, wherein grouping the data objects based on both their respective descriptions and their respective response characteristics comprises grouping the data objects based on features that the data objects have in common and along a dimension related to the response characteristics of the data objects.

10. A computerized method of producing a mechanism model based on features and response characteristics of a set of data objects, said computerized method comprising:
(a) iteratively performing at least the following steps:
(i) establishing a description of each data object, based on a comparison between a set of features of the data objects and a set of descriptors,
(ii) selecting a group of data objects that have similar descriptions and that cooperatively exhibit a particular response characteristic,
(iii) establishing a new descriptor based on commonality of features among the data objects in the selected group, and
(iv) adding said new descriptor to said set of descriptors; and
(b) outputting data indicative of at least one new descriptor learned in step (iv), whereby said new descriptor defines a mechanism model.

11. A computerized method of producing a mechanism model based on features and response characteristics of a set of data objects, said computerized method comprising:
(a) iteratively performing at least the following steps:
(i) establishing a description of each data object, based on a comparison between a set of features of the data objects and a set of descriptors,
(ii) selecting at least one group of data objects that have similar descriptions and that cooperatively exhibit a particular response characteristic, said group of data objects having a set of discriminating features defining similarity of the data objects in said group,
(iii) identifying at least one common subset of features of the data objects in said group based at least in part on a measure of how much said at least one common subset of features participated in defining the discriminating features of said group;
(iv) adding said at least one common subset of features to said set of descriptors as a new descriptor; and
(b) outputting data indicative of at least one common subset of features identified in step (iii), whereby said at least one common subset of features defines a mechanism model.

12. A computerized method as claimed in claim 11, wherein selecting at least one group of data objects that have similar descriptions and that cooperatively exhibit a particular response characteristic comprises:
grouping the data objects based on similarity of their respective descriptions, so as to produce groups of data objects; and
selecting at least one of said groups of data objects that contains data objects having said particular response characteristic.

13. A computerized method as claimed in claim 12, wherein the selected group contains at least a predetermined number of data objects having said particular response characteristic.

14. A computerized method as claimed in claim 12, wherein the selected group contains at least a predetermined percent of data objects having said particular response characteristic.

15. A computerized method as claimed in claim 12, wherein grouping the data objects based On similarity of their respective descriptions comprises clustering said data objects.

16. A computerized method as claimed in claim 12, wherein clustering said data objects comprises applying a self-organizing-map keyed to said descriptors.

17. A computerized method as claimed in claim 11, wherein selecting at least one group of data objects comprises grouping the data objects based on both their respective descriptions and their respective response characteristics.

18. A computerized method for generating a mechanism model defining a feature set likely to give rise to a specified response, said computerized method comprising, in combination:
(a) receiving a data set representing a plurality of objects, each object defining a set of features and a response characteristic;
(b) characterizing each object by a feature vector based on a comparison of a set of reference descriptors with the set of features defined by the object;
(c) clustering the objects based on their feature vectors and thereby producing a set of clusters, each cluster containing one or more objects, and each cluster defining a feature template associated with the features of the one or more objects in the cluster;
(d) selecting a hot spot of clustered objects based at least in part on a concentration of a specified response characteristic among the clustered objects, the hot spot having a set of discriminating features defining similarity among the objects in the hot spot;
(e) mapping the discriminating features of the hot spot to the objects in the hot spot so as to discover a feature set in the hot spot that is common among objects in the hot spot, said feature set defining said mechanism model; and
(f) outputting a data set indicating said mechanism model.

19. A method as claimed in claim 18, further comprising outputting a data set indicating the feature templates of said clusters.

20. A computerized method for producing a mechanism model representing a feature set likely to correspond to a specified response characteristic, said computerized method comprising, in combination:
(a) receiving a data set representing a plurality of data objects, each of said data objects having a set of features and a response characteristic;
(b) assembling a set of descriptors each of which defines a feature set comprising one or more features;
(c) performing the following routine at least twice, with respect to at least a plurality of said data objects:
(i) establishing a vector for each of said data objects, wherein each element of the vector for a data object indicates the presence or absence in said data object of a respective one of the descriptors of said set of descriptors,
(ii) clustering said data objects according to their vectors, so as to establish a set of clusters each containing one or more of said data objects, each of said clusters having a cluster template defining features associated with the one or more data objects in the cluster,
(iii) identifying a group of clustered data objects having at least a threshold concentration of a specified response characteristic, said group of clustered data objects having a set of discriminating features defining similarity among the clustered data objects in said group,
(iv) identifying a subset of said discriminating features that is common to all of the clustered data objects in said group, and
(v) adding said subset of discriminating features as a new descriptor to said set of descriptors; and
(d) outputting a data set indicative of at least one new descriptor, wherein said at least one new descriptor represents said mechanism model.

21. A computerized method of determining a response characteristic of a test data object based on an analysis of a set of training data objects, said test data object defining features, said computerized method comprising in order:
(a) iteratively performing at least the following steps with respect to said set of training data objects, each of said training data objects defining features and a response characteristic:
(i) establishing a descriptor vector for each of said training data objects based on a comparison of features of the training data objects with a set of descriptors,
(ii) clustering the training data objects according to their descriptor vectors, so as to establish a set of clusters, each of the clusters containing one or more training data objects, and each of the clusters having a cluster template defining a weighted set of descriptors, wherein the descriptor vectors of the training data objects in a given cluster most closely match the template of the given cluster compared to the templates of other clusters,
(iii) selecting a group of the clustered training data objects based on a concentration of a particular response characteristic among the clustered training data objects,
(iv) learning a new descriptor based on commonality of features among the clustered training data objects of the selected group, and
(v) adding said new descriptor to said set of descriptors;
(b) establishing a test descriptor vector for said test data object based on a comparison of features of the test data object with the set of descriptors;
(c) selecting as a test cluster the cluster having a template that most closely matches said test descriptor vector;
(d) determining a representative response characteristic of the training data objects in said test cluster; and
(e) concluding that the response characteristic of said test data object is likely to be said representative response characteristic.

22. A computerized method of producing a pharmacophore based on structural features and activity characteristics of a set of molecules, said computerized method comprising:
establishing a description of each molecule, based on a comparison between a set of structural features of the molecules and a set of descriptors;
selecting a group of molecules that have similar descriptions and that cooperatively represent a particular activity characteristic;
establishing said pharmacophore based on commonality of structural features among the molecules in the selected group; and
outputting data indicative of said pharmacophore.

23. A computerized method of producing a pharmacophore based on structural features and activity characteristics of a set of molecules, said computerized method comprising:
establishing a description of each molecule, based on a comparison between a set of structural features of the molecules and a set of descriptors;
selecting at least one group of molecules that have similar descriptions and that cooperatively represent a particular activity characteristic, said group of molecules having a set of discriminating features defining similarity of the molecules in said group;
identifying at least one common subset of features of the molecules in said group based at least in part on a measure of how much said at least one common subset of features participated in defining the discriminating features of said group; and
outputting said at least one common subset of features as a pharmacophore.

24. A computerized method as claimed in claim 23, wherein selecting at least one group of molecules that have similar descriptions and that cooperatively represent a particular activity characteristic comprises:
grouping the molecules based on similarity of their respective descriptions, so as to produce groups of molecules; and
selecting at least one of said groups of molecules that contains molecules having said particular activity characteristic.

25. A computerized method as claimed in claim 24, wherein the selected group contains at least a predetermined number of molecules having said particular activity characteristic.

26. A computerized method as claimed in claim 24, wherein the selected group contains at least a predetermined percent of molecules with said particular activity characteristic.

27. A computerized method as claimed in claim 24, wherein grouping the molecules based on similarity of their respective descriptions comprises clustering data representing said molecules.

28. A computerized method as claimed in claim 24, wherein clustering said data comprises applying a self-organizing-map keyed to said descriptors.

29. A computerized method as claimed in claim 23, wherein selecting at least one group of molecules comprises grouping the molecules based on both their respective descriptions and their respective activity characteristics.

30. A computerized method as claimed in claim 29, wherein grouping the molecules based on both their respective descriptions and their respective activity characteristics comprises grouping the molecules based on structural features that the molecules have in common and along a dimension related to the activity characteristics of the molecules.

31. A computerized method of producing a pharmacophore based on features and activity characteristics of a set of molecules, said computerized method comprising:
(a) iteratively performing at least the following steps:
(i) establishing a description of each molecule based on a comparison between a set of structural features of the molecules and a set of descriptors,
(ii) selecting a group of molecules that have similar descriptions and that cooperatively represent a particular activity characteristic,
(iii) establishing a new descriptor based on commonality of structural features among the molecules in the selected group, and
(iv) adding said new descriptor to said set of descriptors; and
(b) outputting data indicative of at least one new descriptor learned in step (iv), whereby said new descriptor defines a pharmacophore.

32. A computerized method of producing a pharmacophore based on features and activity characteristics of a set of molecules, said computerized method comprising:
(a) iteratively performing at least the following steps:
(i) establishing a description of each molecules, based on a comparison between a set of structural features of the molecules and a set of descriptors,
(ii) selecting at least one group of molecules that have similar descriptions and that cooperatively represent a particular activity characteristic, said group of molecules having a set of discriminating features defining similarity of the molecules in said group,
(iii) identifying at least one common subset of features of the molecules in said group based at least in part on a measure of how much said at least one common subset of features participated in defining the discriminating features of said group;
(iv) adding said at least one common subset of features to said set of descriptors as a new descriptor; and
(b) outputting data indicative of at least one common subset of features identified in step (iii), whereby said at least one common subset of features defines a pharmacophore.

33. A computerized method as claimed in claim 32, wherein selecting at least one group of molecules that have similar descriptions and that cooperatively represent a particular activity characteristic comprises:
grouping the molecules based on similarity of their respective descriptions, so as to produce groups of molecules; and
selecting at least one of said groups of molecules that contains molecules having said particular activity characteristic.

34. A computerized method as claimed in claim 33, wherein the selected group contains at least a predetermined number of molecules having said particular activity characteristic.

35. A computerized method as claimed in claim 33, wherein the selected group contains at least a predetermined percent of molecules having said particular activity characteristic.

36. A computerized method as claimed in claim 33, wherein grouping the molecules based on similarity of their respective descriptions comprises clustering said molecules.

37. A computerized method as claimed in claim 33, wherein clustering said molecules comprises applying a self-organizing-map keyed to said descriptors.

38. A computerized method as claimed in claim 32, wherein selecting at least one group of molecules comprises grouping the molecules based on both their respective descriptions and their respective activity characteristics.

39. A computerized method for producing a pharmacophore representing a chemical structure likely to have a specified activity, said computerized method comprising, in combination:
(a) assembling a set of molecule data strings each representing a molecule, and assembling activity data indicative of an activity characteristic for each of said molecules;
(b) assembling a set of descriptor data strings each representing a descriptor of a chemical structure that may be present or absent in one of said molecules;
(c) performing the following routine at least twice, with respect to at least a plurality of said molecules:
(i) for each of said molecules, establishing a vector indicating for each of said chemical descriptors whether the chemical structure represented by the descriptor data string is present in the molecule represented by the molecule data string,
(ii) clustering said molecules according to their vectors, so as to establish a set of clusters based on structural similarity of the molecules, each of the clusters thus representing one or more of the molecules, and each of the clusters having a cluster template defining a weighted set of descriptors, wherein the vectors of the molecules represented by a given cluster most closely match the template of the given cluster compared to the templates of other clusters,
(iii) identifying a group of clustered molecules having at least a threshold concentration of a specified activity characteristic, said group of clustered molecules having a set of discriminating structural features defining similarity among the clustered molecules in said group,
(iv) identifying a subset of said discriminating structural features that is common to all of the clustered molecules in said group, said subset of discriminating structural features defining a new descriptor, and
(v) adding to said set of descriptor data strings a new data string representing said new descriptor; and
(d) outputting a data set indicative of at least one new descriptor, wherein said at least one new descriptor represents said pharmacophore.

40. A computerized method as claimed in claim 39, wherein assembling a set of molecule data strings each representing a molecule and assembling activity data indicative of an activity characteristic for each of said molecules comprises receiving a single set of data including both said molecule data strings and said activity data per molecule.

41. A computerized method as claimed in claim 39, wherein assembling a set of molecule data strings each representing a molecule and assembling activity data indicative of an activity characteristic for each of said molecules comprises receiving a first data set comprising said molecule data strings and a second data set comprising said activity data.

42. A computerized method as claimed in claim 39, wherein establishing a vector for a molecule comprises querying each of said descriptor data strings against the molecule data string and responsively recording in said vector whether each respective descriptor data string is present in said molecule data string.

43. A computerized method as claimed in claim 39, wherein clustering said molecules according to their vectors comprises clustering their vectors.

44. A computerized method as claimed in claim 39, wherein clustering said molecules according to their vectors comprises applying a self-organizing-map to organize data representing said molecules.

45. A computerized method as claimed in claim 44, wherein said data representing said molecules comprises said vectors.

46. A computerized method as claimed in claim 39,
wherein the activity characteristic of each molecule is active or inactive, and
wherein identifying a group of clustered molecules having at least a threshold concentration of a specified activity characteristic comprises identifying a group of clustered molecules in which no molecule is inactive.

47. A computerized method as claimed in claim 39,
wherein the activity characteristic of each molecule is active or inactive, and
wherein identifying a group of clustered molecules having at least a threshold concentration of a specified activity characteristic comprises identifying a cluster of molecules having more than a predetermined number of active molecules.

48. A computerized method as claimed in claim 39,
wherein clustering said molecules according to their vectors comprises applying a self-organizing-map to organize data representing said molecules, and
wherein identifying a group of clustered molecules having at least a threshold concentration of a specified activity characteristic further comprises evaluating the activity characteristic of neighboring clusters in said self-organizing-map.

49. A computerized method as claimed in claim 39,
wherein clustering said molecules according to their vectors comprises applying a self-organizing-map to organize data representing said molecules, and
wherein the set of discriminating structural features defining similarity among the clustered molecules in the group comprises the template of a cluster containing molecules in said group.

50. A computerized method as claimed in claim 39, wherein identifying a subset of said discriminating structural features that is common to all of the clustered molecules in said group comprises weighing structural components of the molecules in the group according to participation of such structural components in defining the group.

51. A computerized method as claimed in 50, wherein said structural components comprise atoms.

52. A computerized method as claimed in claim 51, wherein said structural components further comprise bonds.

53. A computerized method as claimed in claim 50, wherein weighing structural components of the molecules in the group according to participation of such structural components in defining the group comprises, for each molecule in the group, assigning a weight to each structural component of the molecule based on the number of times the structural component appears in the set of discriminating structural features of said group.

54. A computerized method as claimed in claim 53, wherein identifying a subset of said discriminating structural features that is common to all of the clustered molecules in said group further comprises identifying a maximum common substructure among said clustered molecules.

55. A computerized method as claimed in claim 54, wherein identifying a maximum common substructure among said clustered molecules comprises applying a genetic algorithm.

56. A computerized method as claimed in claim 39, wherein clustering said molecules according to their vectors comprises applying a self-organizing-map to organize data representing said molecules, and
wherein identifying a subset of said discriminating structural features that is common to all of the clustered molecules in said group comprises selecting said subset of discriminating structural features and verifying whether said subset of discriminating structural features is also present in a neighboring cluster in said self-organizing-map.

57. A computerized method as claimed in claim 39, wherein each of said descriptors represents a chemical structure comprising a feature selected from the group consisting of an atom, an atom pair, a bond, a proton donor-acceptor pair, an aromatic ring, a shape, a size and an orientation.

58. A computerized method as claimed in claim 39, wherein each of said activity characteristics represents a single activity measurement from an assay.

59. A computerized method as claimed in claim 39, wherein each of said activity characteristics represents a plurality of activity measurements.

60. A computerized method as claimed in claim 39, further comprising, in a second or later iteration of said routine, when establishing said vector for a molecule in step (a), setting said vector to indicate absence of a chemical structure represented by a descriptor data string if the chemical structure is wholly subsumed by a new feature subset as defined by a new descriptor added in step (v).

61. A computerized method as claimed in claim 39, further comprising, in a second or later iteration of said routine, assessing performance of descriptor learned in a previous iteration.

62. A computerized method for producing a pharmacophore representing a chemical structure likely to have a specified activity, said computerized method comprising, in combination:
assembling a set of molecule data strings each representing a molecule, and assembling activity data indicative of an activity characteristic for each of said molecules;
assembling a set of descriptor data strings each representing a descriptor of a chemical structure that may be present or absent in one of said molecules;
for each of said molecules, establishing a vector indicating for each of said chemical descriptors whether the chemical structure represented by the descriptor data string is present in the molecule represented by the molecule data string;
clustering said molecules according to their vectors, so as to establish a set of clusters based on structural similarity of the molecules, each of the clusters thus representing one or more of the molecules, and each of the clusters having a cluster template defining a weighted set of descriptors, wherein the vectors of the molecules represented by a given cluster most closely match the template of the given cluster compared to the templates of other clusters;
identifying a group of clustered molecules having at least a threshold concentration of a specified activity characteristic, said group of clustered molecules having a set of discriminating structural features defining similarity among the clustered molecules in said group;
identifying a subset of said discriminating structural features that is common to all of the clustered molecules in said group, said subset of discriminating structural features defining a pharmacophore; and
outputting data indicative of said pharmacophore.

63. A computer-readable medium embodying a set of machine language instructions executable by a computer for analyzing an input set of data representing a set of molecules and thereby establishing a pharmacophore, each of said molecules having structural features and an activity characteristic, said machine language instructions comprising instructions for performing the following functions:
establishing a description of each molecule, based on a comparison between a set of structural features of the molecules and a set of descriptors;
selecting at least one group of molecules that have similar descriptions and that cooperatively represent a particular activity characteristic, said group of molecules having a set of discriminating features defining similarity of the molecules in said group;
identifying at least one common subset of features of the molecules in said group based at least in part on a measure of how much said at least one common subset of features participated in defining the discriminating features of said group; and
outputting said at least one common subset of features as a pharmacophore.

64. A processing system for modeling chemical structure-activity relationships through artificial intelligence analysis of a data set representing molecules, each of the molecules having a set of features and an activity characteristic, said processing system comprising, in combination:
means for establishing a description of each molecule, based on a comparison between a set of structural features of the molecules and a set of descriptors;
means for selecting at least one group of molecules that have similar descriptions and that cooperatively represent a particular activity characteristic, said group of molecules having a set of discriminating features defining similarity of the molecules in said group;
means for identifying at least one common subset of features of the molecules in said group based at least in part on a measure of how much said at least one common subset of features participated in defining the discriminating features of said group; and
means for outputting said at least one common subset of features as a mechanism model representing a chemical structure likely to give rise to said particular activity characteristic.

65. A computer-readable medium embodying a set of machine language instructions executable by a computer for analyzing an input set of data representing a set of molecules and thereby establishing a pharmacophore, each of said molecules having structural features and an activity characteristic, said machine language instructions comprising instructions for performing the following functions:
(a) iteratively performing at least the following steps:
(i) establishing a description of each molecules, based on a comparison between a set of structural features of the molecules and a set of descriptors,
(ii) selecting at least one group of molecules that have similar descriptions and that cooperatively represent a particular activity characteristic, said group of molecules having a set of discriminating features defining similarity of the molecules in said group,
(iii) identifying at least one common subset of features of the molecules in said group based at least in part on a measure of how much said at least one common subset of features participated in defining the discriminating features of said group;
(iv) adding said at least one common subset of features to said set of descriptors as a new descriptor; and
(b) outputting data indicative of at least one common subset of features identified in step (iii), whereby said at least one common subset of features defines a pharmacophore.

66. A processing system for modeling chemical structure-activity relationships through artificial intelligence analysis of a data set representing molecules, each of the molecules having a set of features and an activity characteristic, said processing system comprising, in combination:
(a) means for iteratively performing at least the following steps:
(i) establishing a description of each molecules, based on a comparison between a set of structural features of the molecules and a set of descriptors,
(ii) selecting at least one group of molecules that have similar descriptions and that cooperatively represent a particular activity characteristic, said group of molecules having a set of discriminating features defining similarity of the molecules in said group,
(iii) identifying at least one common subset of features of the molecules in said group based at least in part on a measure of how much said at least one common subset of features participated in defining the discriminating features of said group;
(iv) adding said at least one common subset of features to said set of descriptors as a new descriptor; and
(b) means for outputting data indicative of at least one common subset of features identified in step (iii), whereby said at least one common subset of features defines a mechanism model representing a chemical structure likely to give rise to said particular activity characteristic.

67. A computer-readable medium embodying a set of machine language instructions executable by a computer for analyzing an input set of data representing a set of molecules and thereby establishing a pharmacophore representing a chemical structure likely to have a specified activity, each of said molecules having structural features and an activity characteristic, said machine language instructions comprising instructions for performing the following functions:
(a) assembling a set of molecule data strings each representing a molecule, and assembling activity data indicative of an activity characteristic for each of said molecules;
(b) assembling a set of descriptor data strings each representing a descriptor of a chemical structure that may be present or absent in one of said molecules;
(c) performing the following routine at least twice, with respect to at least a plurality of said molecules:
(i) for each of said molecules, establishing a vector indicating for each of said chemical descriptors whether the chemical structure represented by the descriptor data string is present in the molecule represented by the molecule data string,
(ii) clustering said molecules according to their vectors, so as to establish a set of clusters based on structural similarity of the molecules, each of the clusters thus representing one or more of the molecules, and each of the clusters having a cluster template defining a weighted set of descriptors, wherein the vectors of the molecules represented by a given cluster most closely match the template of the given cluster compared to the templates of other clusters,
(iii) identifying a group of clustered molecules having at least a threshold concentration of a specified activity characteristic, said group of clustered molecules having a set of discriminating structural features defining similarity among the clustered molecules in said group,
(iv) identifying a subset of said discriminating structural features that is common to all of the clustered molecules in said group, said subset of discriminating structural features defining a new descriptor, and
(v) adding to said set of descriptor data strings a new data string representing said new descriptor; and
(d) outputting a data set indicative of at least one new descriptor, wherein said at least one new descriptor represents said pharmacophore.

68. A processing system for modeling chemical structure-activity relationships through artificial intelligence analysis of a data set representing molecules, each of the molecules having a set of features and an activity characteristic, said processing system comprising, in combination:
(a) means for assembling a set of molecule data strings each representing a molecule, and assembling activity data indicative of an activity characteristic for each of said molecules;
(b) means for assembling a set of descriptor data strings each representing a descriptor of a chemical structure that may be present or absent in one of said molecules;
(c) a set of machine language instructions executable by a processor for performing the following functions at least twice, with respect to at least a plurality of said molecules:
(i) for each of said molecules, establishing a vector indicating for each of said chemical descriptors whether the chemical structure represented by the descriptor data string is present in the molecule represented by the molecule data string,
(ii) clustering said molecules according to their vectors, so as to establish a set of clusters based on structural similarity of the molecules, each of the clusters thus representing one or more of the molecules, and each of the clusters having a cluster template defining a weighted set of descriptors, wherein the vectors of the molecules represented by a given cluster most closely match the template of the given cluster compared to the templates of other clusters,
(iii) identifying a group of clustered molecules having at least a threshold concentration of a specified activity characteristic, said group of clustered molecules having a set of discriminating structural features defining similarity among the clustered molecules in said group,
(iv) identifying a subset of said discriminating structural features that is common to all of the clustered molecules in said group, said subset of discriminating structural features defining a new descriptor, and
(v) adding to said set of descriptor data strings a new data string representing said new descriptor; and
(d) means for outputting a data set indicative of at least one new descriptor, wherein said at least one new descriptor defines a mechanism model representing a chemical structure likely to give rise to said specified activity characteristic.
